(19) United States
(12) Patent Application Publication
(10) Pub. No.: US 2026/0274741 A1
(43) Pub. Date: Sep. 17, 2026

(54) COMPOSITION FOR MID-INFRARED LIGHT TRANSMITTING GLASS AND METHOD FOR PREPARING SAME

(71) Applicant: KOREA PHOTONICS TECHNOLOGY INSTITUTE, Gwangju (KR)

(72) Inventors: Ju Hyeon CHOI, Gwangju (KR); Jeong Hwan IN, Daejeon (KR); Seon Hoon KIM, Gwangju (KR)

(73) Assignee: KOREA PHOTONICS TECHNOLOGY INSTITUTE, Gwangju (KR)

(21) Appl. No.: 19/685,445

(22) Filed: May 22, 2026

Related U.S. Application Data
(62) Division of application No. 17/777,431, filed on Apr. 21, 2021, now abandoned.

(30) Foreign Application Priority Data
Apr. 27, 2020 (KR) 10-2020-0050852

(51) Int. Cl. C03C 3/12; C03C 4/10

(52) U.S. Cl. CPC C03C 3/122; C03C 4/10

(57) ABSTRACT

A composition for mid-infrared light transmitting glass and a method for preparing same are disclosed. Provided according to an embodiment of the present invention are a composition for mid-infrared light transmitting glass and a method for preparing same, wherein the composition can be manufactured into a lens that has both excellent optical properties and physical properties.

### CROSS-REFERENCE TO RELATED APPLICATIONS

This application is a divisional application of U.S. Patent Application No. 17/777,431 filed on May 17, 2022, which is a national phase entry of International Application No. PCT/KR2021/005004 filed on April 21, 2021, which claims priority to Korean Patent Application No. 10-2020-0050852 filed on April 27, 2020, the entire contents of which are herein incorporated by reference.

### TECHNICAL FIELD

The present invention relates to a composition for glass that transmits light in a mid-infrared wavelength band and a method for manufacturing the same.

### BACKGROUND ART

The description of the Discussion of Related Art section merely provides information that may be relevant to embodiments of the disclosure but should not be appreciated as necessarily constituting the prior art.

Mid-infrared transmitting lenses have been mainly used in the military field for the purpose of image processing for tracking, e.g., missiles. Since the mid-infrared transmitting lenses used in the military field should maintain excellent performance even in a high-temperature environment, the lenses have been manufactured by forming crystals, such as of germanium, one by one into the shape of a lens. Therefore, mid-infrared transmitting lens for military use are difficult to use in the civil field due to high material costs and low productivity.

Meanwhile, there is increasing demand for external infrared lenses that may be used in small terminals, such as smartphones, in the civil sector as well. Accordingly, conventional infrared transmitting lenses are formed of a chalcogenide and have been used in various fields that require transmission of infrared rays.

However, chalcogenides are able to transmit mid-infrared rays (3μm to 5μm) and far-infrared rays (15μm or more) and are thus available as a material for mid-infrared transmitting lenses. However, since chalcogenides have a remarkably low glass transition temperature of about 350°C, chalcogenide glass lenses cannot be used in industrial environments including furnaces, glass manufacturing plants, and high-temperature processes. In sum, infrared transmitting lenses formed of chalcogenides may operate smoothly in a normal temperature environment but may not, in a high temperature environment of several hundred ℃ or more due to a significant change in lens shape and optical properties. For example, in factories or furnaces that process high-temperature materials, because of the above-described characteristics, conventional infrared transmitting lenses formed of an expensive crystalline material should be used. Therefore, as compared to far-infrared cameras, high-resolution mid-infrared cameras have been adopted only in the military sector and it was difficult to expand the market to the civil sector.

Therefore, there is increasing demand for mid-infrared transmitting lenses that may be adopted in various environments of the civil field by replacing conventional Ge, ZnS, ZnSe or crystal materials and have superior productivity and reduced costs by applying a molding process.

### DETAILED DESCRIPTION OF THE INVENTION

### TECHNICAL PROBLEMS

An embodiment of the present invention aims to provide a composition for mid-infrared transmitting glass for manufacturing a lens having superior optical and physical properties and a method for manufacturing the same.

An embodiment of the present invention also aims to provide a composition for mid-infrared transmitting glass for mass-producing lenses having superior optical and physical properties and a method for manufacturing the same.

### MEANS TO ADDRESS THE PROBLEMS

According to an embodiment of the present invention, there is provided a composition for glass transmitting a mid-infrared wavelength band of light by a preset reference value or more, wherein the composition includes preset contents of TeO2, La2O3, and ZnO.

According to an embodiment of the present invention, the composition includes 55mol% to 80mol% of TeO₂, 5mol% to 10mol% of La₂O₃, and 10mol% to 40mol% of ZnO.

According to an embodiment of the present invention, there is provided a composition for glass transmitting a mid-infrared wavelength band of light by a preset reference value or more, wherein the composition includes preset contents of TeO₂, La₂O₃, and BaO.

According to an embodiment of the present invention, the composition includes 70mol% to 80mol% of TeO₂, 10mol% of La₂O₃, and 10mol% to 20mol% of BaO.

According to an embodiment of the present invention, there is provided a composition for glass transmitting a mid-infrared wavelength band of light by a preset reference value or more, wherein the composition includes preset contents of TeO₂, BaO, and ZnO.

According to an embodiment of the present invention, the composition includes 50mol% to 70mol% of TeO₂, 5mol% to 20mol% of BaO, and 20mol% to 30mol% of ZnO.

According to an embodiment of the present invention, there is provided a composition for glass transmitting a mid-infrared wavelength band of light by a preset reference value or more, wherein the composition includes preset contents of TeO₂, ZnO, and La₂O₃ and a preset content of dopant to change an optical property of the glass.

According to an embodiment of the present invention, the dopant is Nb₂O₃, MoO₃, or ZnF₂.

According to an embodiment of the present invention, the composition includes 65mol% to 70mol% of TeO₂, 5mol% to 20mol% of ZnO, 10mol% of La₂O₃, and 5mol% to 15mol% of the dopant.

According to an embodiment of the present invention, there is provided a composition for glass transmitting a mid-infrared wavelength band of light by a preset reference value or more, wherein the composition includes preset contents of TeO₂, BaO, and ZnO and a preset content of dopant to change an optical property of the glass.

According to an embodiment of the present invention, the dopant is Nb₂O₃ or MoO₃.

According to an embodiment of the present invention, the composition includes 65mol% of TeO₂, 10mol% of BaO, 20mol% to 25mol% of ZnO, and 5mol% to 10mol% of the dopant.

According to an embodiment of the present invention, there is provided a composition for glass transmitting a mid-infrared wavelength band of light by a preset reference value or more, wherein the composition includes preset contents of TeO₂, BaO, and La₂O₃ and a preset content of dopant to change an optical property of the glass.

According to an embodiment of the present invention, the dopant is Nb₂O₃ or MoO₃.

According to an embodiment of the present invention, the composition includes 70mol% of TeO₂, 5mol% to 15mol% of BaO, 10mol% of La₂O₃, and 5mol% to 15mol% of the dopant.

According to an embodiment of the present invention, there is provided a method for preparing a composition for glass transmitting a mid-infrared wavelength band of light by a preset reference value or more, comprising mixing preset contents of preset raw materials including TeO2, melting the mixed materials at a preset first temperature for a preset first time, and annealing the molten materials in a mold in a preset first environment.

According to an embodiment of the present invention, the method further comprises charging the mixed materials into a preset container and exposing in a preset second environment for a preset second time.

According to an embodiment of the present invention, the preset raw materials include any two of La₂O₃, BaO, and ZnO.

### EFFECTS OF THE INVENTION

As described above, according to an embodiment of the present invention, it is possible to manufacture a lens having superior optical and physical properties.

According to an embodiment of the present invention, it is possible to secure productivity in manufacturing a lens with a composition for mid-infrared transmitting glass.

### BRIEF DESCRIPTION OF THE DRAWINGS

FIG. 1 is a flowchart illustrating a method for preparing a composition for mid-infrared transmitting glass according to an embodiment of the present invention.

FIG. 2 is a ternary system illustrating the content of components constituting a composition for mid-infrared transmitting glass according to a first embodiment of the present invention.

FIG. 3 is a view illustrating mid-infrared transmitting glass according to the first embodiment of the present invention.

FIG. 4 is a graph illustrating the transmittance for each wavelength of a composition for mid-infrared transmitting glass according to the first embodiment of the present invention.

FIG. 5 is a graph illustrating the glass transition temperature, the peak temperature, and the thermal stability according to the composition of a composition for mid-infrared light transmitting glass according to the first embodiment of the present invention.

FIG. 6 is a graph illustrating the glass transition temperature and softening temperature according to the composition of the composition for mid-infrared light transmitting glass according to the first embodiment of the present invention.

FIG. 7 is a graph illustrating the hardness according to the composition of a composition for mid-infrared transmitting glass according to the first embodiment of the present invention.

FIG. 8 is a ternary system illustrating the content of components constituting a composition for mid-infrared transmitting glass according to a second embodiment of the present invention.

FIG. 9 is a view illustrating mid-infrared transmitting glass according to the second embodiment of the present invention.

FIG. 10 is a graph illustrating the transmittance for each wavelength of a composition for mid-infrared transmitting glass according to the second embodiment of the present invention.

FIG. 11 is a graph illustrating the glass transition temperature, the peak temperature, and the thermal stability according to the composition of a composition for mid-infrared light transmitting glass according to the second embodiment of the present invention.

FIG. 12 is a graph illustrating the glass transition temperature and softening temperature according to the composition of the composition for mid-infrared light transmitting glass according to the second embodiment of the present invention.

FIG. 13 is a graph illustrating the hardness according to the composition of a composition for mid-infrared transmitting glass according to the second embodiment of the present invention.

FIG. 14 is a view illustrating the content of components constituting a composition for mid-infrared transmitting glass according to a third embodiment of the present invention.

FIG. 15 is a view illustrating mid-infrared transmitting glass according to the third embodiment of the present invention.

FIG. 16 is a graph illustrating the glass transition temperature, the crystallization temperature, and the thermal stability according to the composition of a composition for mid-infrared light transmitting glass according to the third embodiment of the present invention.

FIG. 17 is a graph illustrating the glass transition temperature and softening temperature according to the composition of the composition for mid-infrared light transmitting glass according to the third embodiment of the present invention.

FIG. 18 is a view illustrating the content of components constituting a composition for mid-infrared transmitting glass according to a fourth embodiment of the present invention.

FIG. 19 is a view illustrating mid-infrared transmitting glass according to the fourth embodiment of the present invention.

FIG. 20 is a view illustrating the content of components constituting a composition for mid-infrared transmitting glass according to a fifth embodiment of the present invention.

FIG. 21 is a view illustrating mid-infrared transmitting glass according to the fifth embodiment of the present invention.

FIG. 22 is a graph illustrating the transmittance for each wavelength of a composition for mid-infrared transmitting glass according to the fifth embodiment of the present invention.

FIG. 23 is a view illustrating the content of components constituting a composition for mid-infrared transmitting glass according to a sixth embodiment of the present invention.

FIG. 24 is a view illustrating mid-infrared transmitting glass according to the sixth embodiment of the present invention.

FIG. 25 is a graph illustrating the transmittance for each wavelength of a composition for mid-infrared transmitting glass according to the sixth embodiment of the present invention.

FIG. 26 is a graph illustrating the glass transition temperature, the crystallization temperature, and the thermal stability according to the composition of a composition for mid-infrared light transmitting glass according to the sixth embodiment of the present invention.

FIG. 27 is a graph illustrating the glass transition temperature and softening temperature according to the composition of the composition for mid-infrared light transmitting glass according to the sixth embodiment of the present invention.

FIG. 28 is a graph illustrating the thermal expansion coefficient according to the composition of a composition for mid-infrared transmitting glass according to the sixth embodiment of the present invention.

FIG. 29 is a view illustrating the content of components constituting a composition for mid-infrared transmitting glass according to a seventh embodiment of the present invention.

FIG. 30 is a view illustrating mid-infrared transmitting glass according to the seventh embodiment of the present invention.

FIG. 31 is a view illustrating the content of components constituting a composition for mid-infrared transmitting glass according to an eighth embodiment of the present invention.

FIG. 32 is a view illustrating mid-infrared transmitting glass according to the eighth embodiment of the present invention.

FIG. 33 is a graph illustrating the glass transition temperature, the crystallization temperature, and the thermal stability according to the composition of a composition for mid-infrared light transmitting glass according to the eighth embodiment of the present invention.

FIG. 34 is a graph illustrating the glass transition temperature and softening temperature according to the composition of the composition for mid-infrared light transmitting glass according to the eighth embodiment of the present invention.

FIG. 35 is a graph illustrating the thermal expansion coefficient according to the composition of a composition for mid-infrared transmitting glass according to the eighth embodiment of the present invention.

FIG. 36 is a view illustrating the content of components constituting a composition for mid-infrared transmitting glass according to a ninth embodiment of the present invention.

FIG. 37 is a view illustrating mid-infrared transmitting glass according to the ninth embodiment of the present invention.

FIG. 38 is a view illustrating the content of components constituting a composition for mid-infrared transmitting glass according to a tenth embodiment of the present invention.

FIG. 39 is a view illustrating mid-infrared transmitting glass according to the tenth embodiment of the present invention.

FIG. 40 is a graph illustrating the glass transition temperature, the crystallization temperature, and the thermal stability according to the composition of a composition for mid-infrared light transmitting glass according to the tenth embodiment of the present invention.

FIG. 41 is a graph illustrating the glass transition temperature and softening temperature according to the composition of the composition for mid-infrared light transmitting glass according to the tenth embodiment of the present invention.

FIG. 42 is a graph illustrating the thermal expansion coefficient according to the composition of a composition for mid-infrared transmitting glass according to the tenth embodiment of the present invention.

FIG. 43 is a view illustrating the content of components constituting a composition for mid-infrared transmitting glass according to an eleventh embodiment of the present invention.

FIG. 44 is a graph illustrating the transmittance for each wavelength of a composition for mid-infrared transmitting glass according to the eleventh embodiment of the present invention.

FIG. 45 is a graph illustrating the glass transition temperature, the crystallization temperature, and the thermal stability according to the composition of a composition for mid-infrared light transmitting glass according to the eleventh embodiment of the present invention.

FIG. 46 is a graph illustrating the refractive index according to the composition of a composition for mid-infrared transmitting glass according to the eleventh embodiment of the present invention.

FIG. 47 is a view illustrating the content of components constituting a composition for mid-infrared transmitting glass according to a twelfth embodiment of the present invention.

FIG. 48 is a graph illustrating the transmittance for each wavelength of a composition for mid-infrared transmitting glass according to the twelfth embodiment of the present invention.

FIG. 49 is a graph illustrating the glass transition temperature, the crystallization temperature, and the thermal stability according to the composition of a composition for mid-infrared light transmitting glass according to the twelfth embodiment of the present invention.

FIG. 50 is a graph illustrating the refractive index according to the composition of a composition for mid-infrared transmitting glass according to the twelfth embodiment of the present invention.

FIG. 51 is a graph illustrating the hardness according to the composition of a composition for mid-infrared transmitting glass according to the twelfth embodiment of the present invention.

FIG. 52 is a view illustrating the content of components constituting a composition for mid-infrared transmitting glass according to a thirteenth embodiment of the present invention.

FIG. 53 is a graph illustrating the transmittance for each wavelength of a composition for mid-infrared transmitting glass according to the thirteenth embodiment of the present invention.

FIG. 54 is a graph illustrating the glass transition temperature, the crystallization temperature, and the thermal stability according to the composition of a composition for mid-infrared light transmitting glass according to the thirteenth embodiment of the present invention.

FIG. 55 is a graph illustrating the refractive index according to the composition of a composition for mid-infrared transmitting glass according to the thirteenth embodiment of the present invention.

FIG. 56 is a view illustrating the content of components constituting a composition for mid-infrared transmitting glass according to a fourteenth embodiment of the present invention.

FIG. 57 is a graph illustrating the transmittance for each wavelength of a composition for mid-infrared transmitting glass according to the fourteenth embodiment of the present invention.

FIG. 58 is a graph illustrating the glass transition temperature, the crystallization temperature, and the thermal stability according to the composition of a composition for mid-infrared light transmitting glass according to the fourteenth embodiment of the present invention.

FIG. 59 is a graph illustrating the hardness according to the composition of a composition for mid-infrared transmitting glass according to the fourteenth embodiment of the present invention.

### MODE TO PRACTICE THE INVENTION

Various changes may be made to the present invention, and the present invention may come with a diversity of embodiments. Some embodiments of the present invention are shown and described in connection with the drawings. However, it should be appreciated that the present disclosure is not limited to the embodiments, and all changes and/or equivalents or replacements thereto also belong to the scope of the present disclosure. Similar reference denotations are used to refer to similar elements throughout the drawings.

The terms "first" and "second" may be used to describe various components, but the components should not be limited by the terms. The terms are used to distinguish one component from another. For example, a first component may be denoted a second component, and vice versa without departing from the scope of the present disclosure. The term "and/or" may denote a combination(s) of a plurality of related items as listed or any of the items.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when a component is "directly connected to" or "directly coupled to" another component, no other intervening components may intervene therebetween.

The terms as used herein are provided merely to describe some embodiments thereof, but not to limit the present disclosure. As used herein, the singular forms “a,” “an,” and “the” are intended to include the plural forms as well, unless the context clearly indicates otherwise. As used herein, the term "comprise," "include," or "have" should be appreciated not to preclude the presence or addability of features, numbers, steps, operations, components, parts, or combinations thereof as set forth herein.

Unless otherwise defined, all terms including technical and scientific terms used herein have the same meaning as commonly understood by one of ordinary skill in the art to which the embodiments of the present disclosure belong.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The components, processes, steps, or methods according to embodiments of the disclosure may be shared as long as they do not technically conflict with each other.

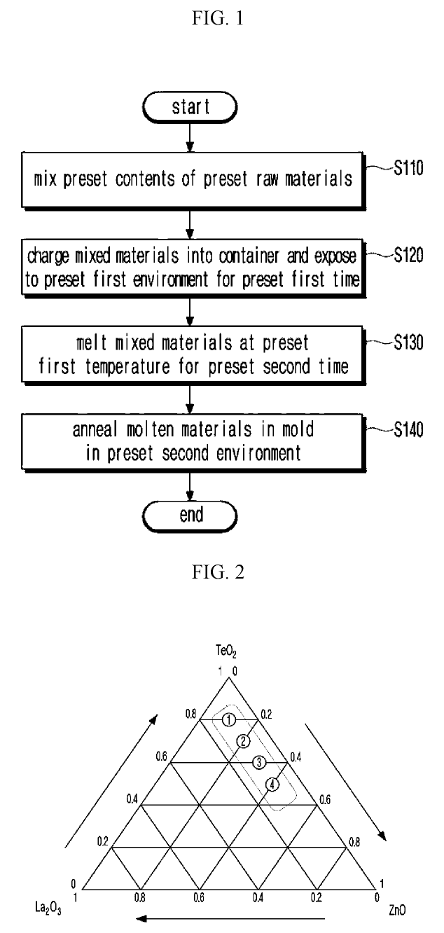

FIG. 1 is a flowchart illustrating a method for preparing a composition for mid-infrared transmitting glass according to an embodiment of the present invention.

The composition for glass is manufactured into mid-infrared transmitting glass through a manufacturing process to be described below. The mid-infrared transmitting glass has a transmittance larger than or equal to a preset reference value for light in a mid-infrared wavelength band among incident light. Mid-infrared transmitting glass may be adopted and used not only in the military field but also in the civil field, such as an environment where it is difficult to identify objects with the naked eye due to heavy chemical gas, fog, and sea fog, or environments where high-temperature objects, such as in factories or furnaces, need to be monitored for leaks, in various forms. Mid-infrared transmitting glass may be used as glass itself but, in many cases, it is shaped into optical components, such as lenses. As each composition for mid-infrared transmitting glass, according to an embodiment of the present invention, is mixed by a preset ratio and undergoes the following manufacturing process, it is possible to mass-produce mid-infrared transmitting lenses having superior optical and physical properties.

Preset raw materials in their respective preset amounts are mixed (S110).

The raw materials constituting the composition for glass may include a main component and a dopant. The main component is a component that must be included in order for raw materials to be manufactured into a composition for mid-infrared transmitting glass or mid-infrared transmitting glass. TeO₂, as a main component, is necessarily included, and any two of ZnO, BaO, and La₂O₃ are optionally included. Depending on the components selected, the content of each main component varies. When TeO₂, La₂O₃ and ZnO are included as main components, TeO₂ in the range of 55 to 80 mol%, La₂O₃ in the range of 5 to 10 mol%, and ZnO in the range of 10 to 40 mol% may be included. When TeO₂, La₂O₃ and BaO are included as main components, TeO₂ in the range of 70 to 80 mol%, La₂O₃ of 10 mol%, and BaO in the range of 10 to 20 mol% may be included. When TeO₂, BaO, and ZnO are included as main components, TeO₂ in the range of 50 to 70 mol%, BaO in the range of 5 to 20 mol%, and ZnO in the range of 20 to 30 mol% may be included. As the selected components in the above-described amounts are included as the main component of the raw materials, it is possible to secure a glass formation area. Further, the mid-infrared lens finally manufactured may secure superior optical properties, such as mid-infrared transmittance, thermal stability, or refractive index by appropriately adjusting the contents of the selected components. As the refractive index increases, the mid-infrared lens may be designed to have a thin thickness and thus may be manufactured as an optical system having a thin structure. Further, since the surface depth (shape) of the lens may be designed to be small, the manufacturing yield of the lens may be enhanced.

The raw materials constituting the composition for glass may include a dopant in addition to the main component. The dopant is a component that allows the glass to additionally have desired physical properties, e.g., hardness, without impairing the optical properties of the mid-infrared transmitting lens to be manufactured. As the dopant, any one of ZnF₂, MoO₃ or Nb₂O₃ may be included. According to components selected as the main components and the content of each component, an appropriate dopant is selected and added in an appropriate amount. When an appropriate dopant is selected and added in an appropriate amount, the desired physical properties of the glass may be enhanced without impairing the optical properties of the mid-infrared transmitting lens to be manufactured.

The raw materials including the main component or the main component and the dopant are mixed. In mixing, ball-milling may be used. Each raw material may be put in a container, e.g., a Nalgene bottle, and the raw materials may be mixed by a zirconia ball having a predetermined amount of material and a predetermined volume. The raw materials may go through the above-described mixing process and may be mixed for a preset time (e.g., 1 hour).

The mixed materials are charged into a container and are exposed for a preset first time in a preset first environment (S120).

The raw materials mixed by the above-described process are charged into a preset container. Here, the preset container may be a platinum crucible having a size larger than or equal to a reference value. In particular, the platinum crucible has a size equal to or larger than the reference value, e.g., 2,000 cc. When the raw materials are manufactured into a composition for glass or glass, the manufactured glass particles should have a predetermined size or more (bulk-up) to increase the yield in forming the glass into an optical component. However, when the mixed raw materials are charged into a container having a predetermined reference value (size) or less and undergoes a process to be described below, the manufactured glass particles become too fine. Since the glass composition or glass prepared in this way is inappropriate for forming into an optical component, the mixed materials are charged into the preset container.

After charged into the container, the mixed materials are exposed for the preset first time in the preset first environment. The preset first environment may have a temperature of about 300°C under a nitrogen atmosphere. For example, such an environment may be formed while the container (platinum crucible) containing the raw materials is placed in an electric furnace in a nitrogen atmosphere. As the raw materials may be so exposed to the preset first environment, surface water is removed. The OH groups contained in the raw materials have a property of absorbing light in the mid-infrared wavelength band, causing a problem of lowering the mid-infrared transmittance of the manufactured glass or an optical component formed of the glass. Accordingly, as the raw materials charged into the container are exposed to the preset first environment, the OH groups in the raw materials are removed. The raw materials are exposed for the preset first time (e.g., 1 hour) in the preset first environment so that OH groups in the raw materials may be sufficiently removed.

The mixed materials are melted at a preset first temperature for a preset second time (S130). The materials that have undergone the surface water removal process are melted at the preset first temperature, e.g., about 900° C, for the preset second time, e.g., 2 hours to 4 hours.

After formed in molds, the molten materials are annealed in a preset second environment (S140). After casted in molds, the molten materials undergo a forming process, e.g., pressing. The materials that have undergone the forming process are annealed in the preset second environment and are manufactured into mid-infrared transmitting glass. In this case, the molten materials are vitrified through a quenching process, and, in the quenching process, stress is generated thereinside. The molten materials are annealed in the preset second environment to relieve the stress. Here, the preset second environment has a temperature that is a preset temperature (e.g., 10 ℃ to 20 ℃ or more) more than the glass transition temperature (Tg) according to the main material included in the raw materials. The molten materials are annealed from the temperature of the preset second environment to room temperature and are prepared into a composition for medium-infrared transmitting glass or medium-infrared transmitting glass.

FIG. 2 is a ternary system illustrating the content of components constituting a composition for mid-infrared transmitting glass according to a first embodiment of the present invention.

The composition for mid-infrared transmitting glass according to the first embodiment of the present invention (hereinafter, abbreviated as a 'first composition') is prepared by including TeO₂, La₂O₃ and ZnO as raw materials. To prepare the first composition, TeO₂, La₂O₃, and ZnO may be included by the following contents.

1) TeO₂: 80mol%, La₂O₃: 10mol%, ZnO: 10mol%

2) TeO₂: 70mol%, La₂O₃: 10mol%, ZnO: 20mol%

3) TeO₂: 60mol%, La₂O₃: 10mol%, ZnO: 30mol%

4) TeO₂: 55mol%, La₂O₃: 5mol%, ZnO: 40mol%

In preparing each first composition, the content of ZnO was varied and as the content of ZnO was varied, the content of TeO₂ or the contents of TeO₂ and La₂O₃ were also varied.

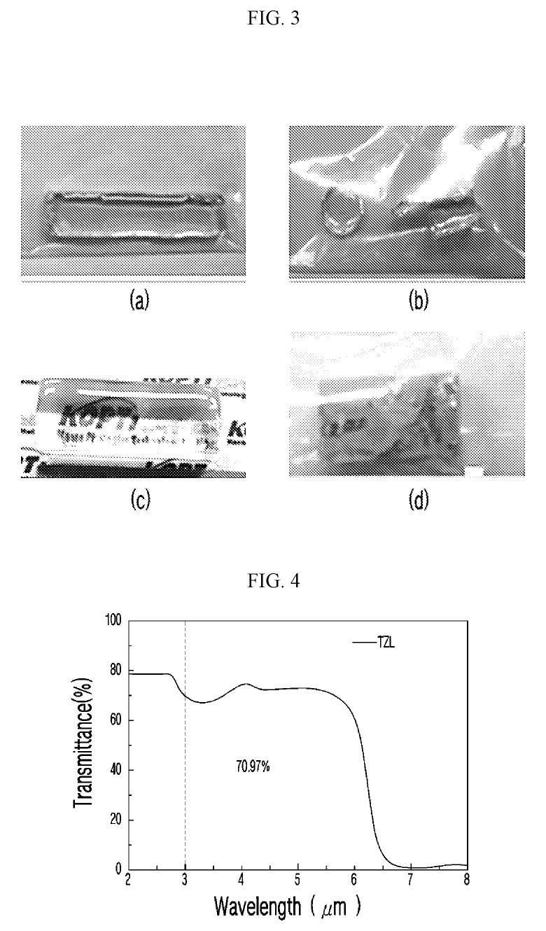

The glass formed of the first composition including each raw material in the above-described content is shown in FIG. 3.

FIG. 3 is a view illustrating mid-infrared transmitting glass according to the first embodiment of the present invention.

FIG. 3(a) to (d) show the glass formed of each first composition. Referring to FIG. 3(a) to (d), it could be identified that crystallization did not proceed in each first composition as they were implemented into glass.

FIG. 4 is a graph illustrating the transmittance for each wavelength of a composition for mid-infrared transmitting glass according to the first embodiment of the present invention. The transmittances of the first composition and the compositions to be mentioned below were measured with an FTIR/UV-VIS spectrometer.

Each first composition has a light transmittance as in the graph shown in FIG. 4. Here, each first compositions showed a high transmittance of 70% or more on average, at a wavelength from 3 to 5 μm, which is a mid-infrared wavelength band. Accordingly, each first compositions has properties suitable for being implemented as mid-infrared transmitting glass. Furthermore, the glass formed of each first composition has excellent releasability, so that anti-reflection (AR) coating may be performed on the surface. When anti-reflection coating is performed on the surface of the glass formed of each first composition, a better mid-infrared transmittance may be secured.

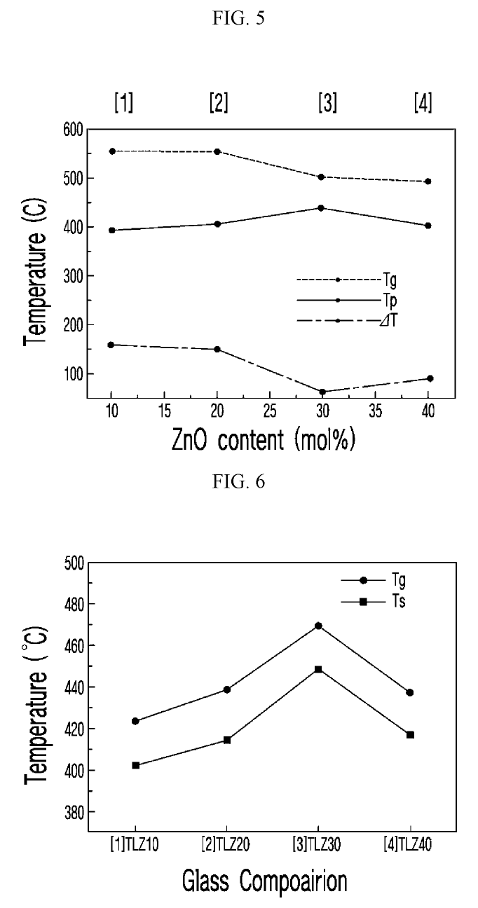

FIG. 5 is a graph illustrating the glass transition temperature, the peak temperature, and the thermal stability according to the composition of a composition for mid-infrared light transmitting glass according to the first embodiment of the present invention. The glass transition temperatures and peak temperatures of the first composition and the compositions to be mentioned below were measured by TG-DTA (STA409PC, NETZSCH) in a sample size of the powder.

Thermal stability is a factor calculated based on the difference between the crystallization temperature (Tₓ) and the glass transition temperature (T_{g}) and is a factor that may determine whether crystallization proceeds when the manufactured glass is formed into an optical component. The glass is reheated, softened, and then molded and cooled into a desired shape (e.g., a lens shape) and is formed into an optical component. If the thermal stability of the composition forming the glass is low in the process, the glass may cause crystallization while cooled after softened. Crystallization scatters incident light, causing a decrease in the transmittance of the glass.

Therefore, thermal stability should be high for the glass formed of the composition to have superior optical properties without crystallization when formed into an optical component while having superior mass-productivity. Typically, if the thermal stability is 100°C or higher, crystallization seldom occurs in the process of forming into an optical component, and the composition is determined to have thermal stability. Furthermore, if the thermal stability is 130°C or higher, the composition is determined to have significantly excellent thermal stability.

However, when the crystallization temperature is not clear during thermal analysis of the compositions, thermal stability between relative compositions may be evaluated using the difference between the peak temperature (Tₚ) and the glass transition temperature.

Referring to the graph shown in FIG. 5, as the content of ZnO in the first composition decreases, thermal stability (calculated based on the difference between the peak temperature and the glass transition temperature) tends to increase. In particular, when 20mol% or less of ZnO was contained in the composition, it could be identified that the composition had significantly excellent thermal stability of 150°C or higher.

FIG. 6 is a graph illustrating the glass transition temperature and softening temperature according to the composition of the composition for mid-infrared light transmitting glass according to the first embodiment of the present invention.

The softening temperature is a temperature at which the glass (first composition), which is a solid material, is deformed to start softening by heat so as to form the glass (composition for glass). If the softening temperature of the composition is too high, it may be difficult to form the glass formed of the composition of glass into an optical component. Accordingly, the mass productivity of glass into optical components is degraded. Further, if the softening temperature is too high, crystallization may occur in the glass during the process of heating and soften the glass for forming. Therefore, it is preferable that the composition for glass has a softening temperature equal to or lower than a predetermined reference value. The reference value may be 520℃.

Referring to the graph shown in FIG. 6, it could be identified that regardless of the content of ZnO in the first composition, the composition had a significantly low softening temperature, and in particular when 20mol% or less of ZnO or 40mol% of ZnO was contained in the composition, the composition had a relatively lower softening temperature.

FIG. 7 is a graph illustrating the hardness according to the composition of a composition for mid-infrared transmitting glass according to the first embodiment of the present invention. The hardness of the first composition and the compositions to be mentioned below was measured by a Micro-Vickers hardness tester (Mitutoyo, HM-220B).

Referring to FIG. 7, the glass formed of the first composition has a tendency to become harder as the content of ZnO increases. It could be identified that when the content of ZnO was 30 mol%, the hardness was highest, and the glass formed of the first composition had a hardness of 335KgF/mm² or more regardless of the content.

It could be identified that when glass was formed of each first composition including the above-described contents, the glass had superior optical and physical properties as described in connection with FIGS. 4 to 7.

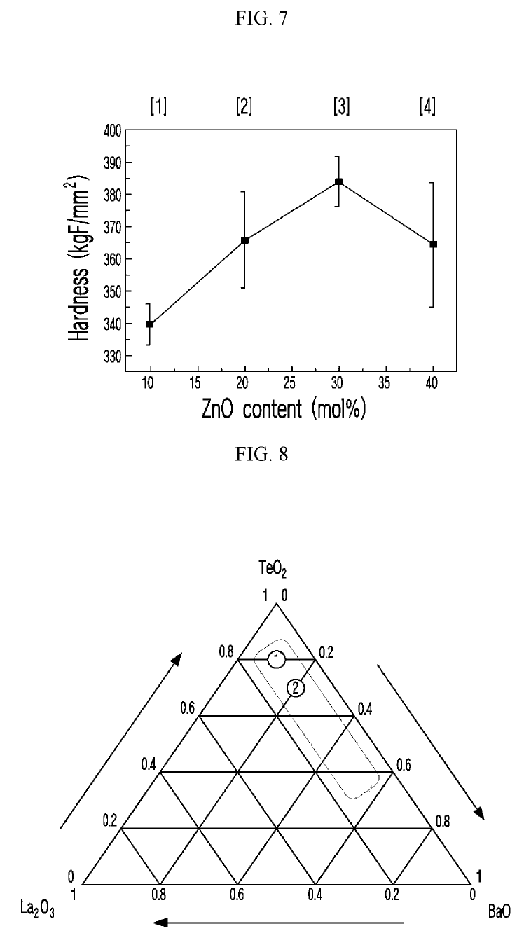

FIG. 8 is a ternary system illustrating the content of components constituting a composition for mid-infrared transmitting glass according to a second embodiment of the present invention.

The composition for mid-infrared transmitting glass according to the second embodiment of the present invention (hereinafter, abbreviated as a 'second composition') is prepared by including TeO₂, La₂O₃ and BaO as raw materials. To prepare the second composition, TeO₂, La₂O₃, and BaO may be included by the following contents.

1) TeO₂: 80mol%, La₂O₃: 10mol%, BaO: 10mol%

2) TeO₂: 70mol%, La₂O₃: 10mol%, BaO: 20mol%

In preparing each second composition, the content of BaO was varied and, as the content of BaO was varied, the content of TeO₂ was varied as well.

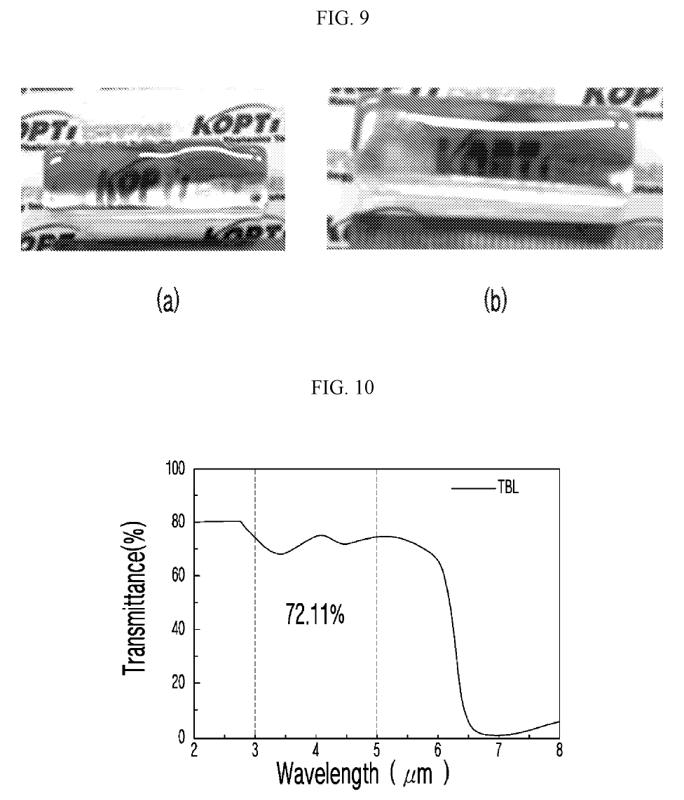

The glass formed of the second composition including each raw material in the above-described content is shown in FIG. 9.

FIG. 9 is a view illustrating mid-infrared transmitting glass according to the second embodiment of the present invention.

FIG. 9(a) and (b) show the glass formed of each second composition. Referring to FIG. 9(a) and (b), it could be identified that crystallization did not proceed in each second composition as they were implemented into glass.

FIG. 10 is a graph illustrating the transmittance for each wavelength of a composition for mid-infrared transmitting glass according to the second embodiment of the present invention.

Each second composition has a light transmittance as in the graph shown in FIG. 10. Here, each second compositions showed a high transmittance of 72% or more on average, at a wavelength from 3 to 5 μm, which is a mid-infrared wavelength band. Accordingly, each second compositions has properties suitable for being implemented as mid-infrared transmitting glass. Furthermore, the glass formed of each second composition has excellent releasability, so that anti-reflection coating may be performed on the surface. When anti-reflection coating is performed on the surface of the glass formed of each second composition, the glass may secure a mid-infrared transmittance equal to or higher than the above-described transmittance.

FIG. 11 is a graph illustrating the glass transition temperature, the peak temperature, and the thermal stability according to the composition of a composition for mid-infrared light transmitting glass according to the second embodiment of the present invention.

Referring to the graph shown in FIG. 11, it could be identified that the second compositions all had thermal stability of 100°C or higher regardless of the content of BaO. In particular, as the content of BaO in the second composition increased, the composition had higher thermal stability.

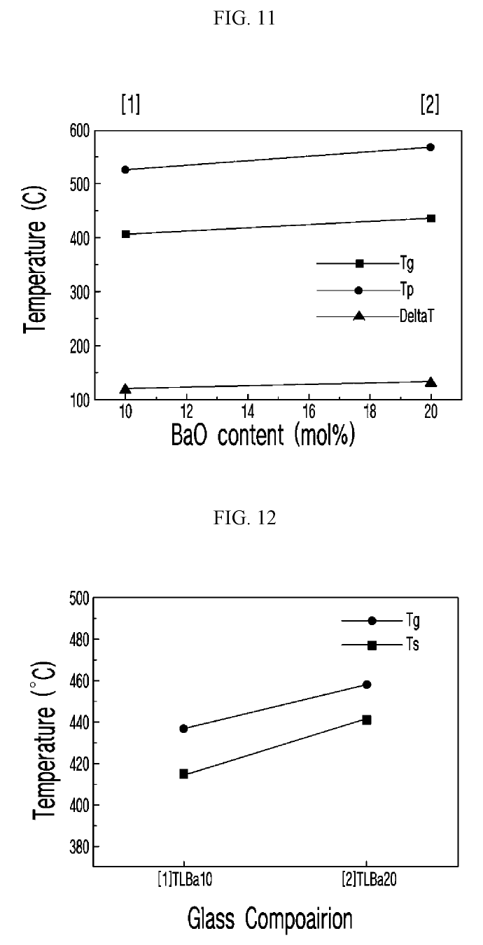

FIG. 12 is a graph illustrating the glass transition temperature and softening temperature according to the composition of the composition for mid-infrared light transmitting glass according to the second embodiment of the present invention.

Referring to the graph shown in FIG. 12, it could be identified that all of the second composition had a softening temperature significantly lower than the reference value (550°C) regardless of the content of BaO in the second compositions. As the content of BaO in the second composition decreased, the composition had a lower softening temperature.

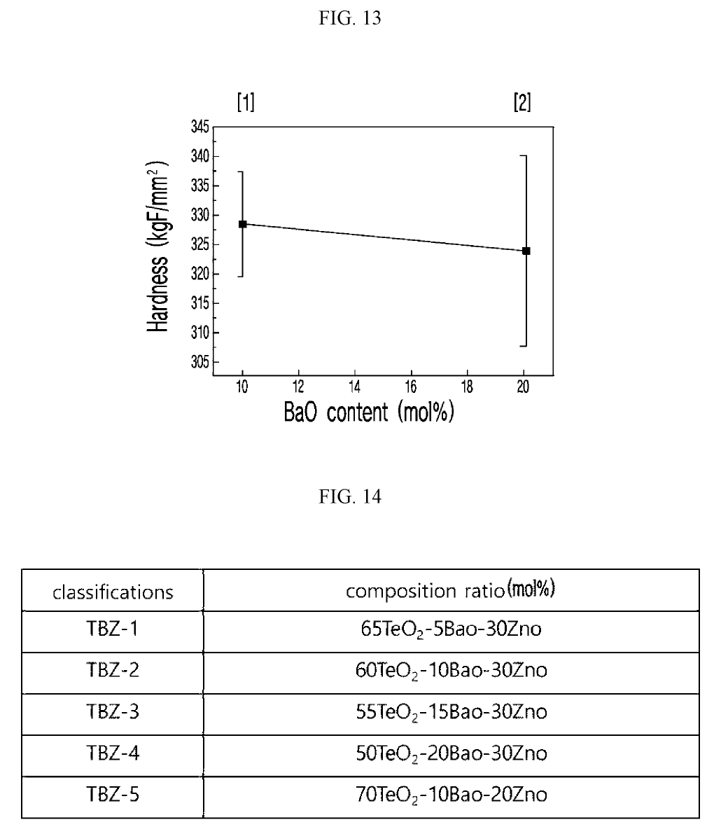

FIG. 13 is a graph illustrating the hardness according to the composition of a composition for mid-infrared transmitting glass according to the second embodiment of the present invention.

Referring to FIG. 13, the glass formed of the second composition has a tendency to become harder as the content of BaO decreases. It could be identified that regardless of the content, the glass formed of the second composition had a hardness of 320KgF/mm² or more.

It could be identified that when glass was formed of each second composition including the above-described contents, the glass had superior optical and physical properties as described in connection with FIGS. 10 to 13.

FIG. 14 is a view illustrating the content of components constituting a composition for mid-infrared transmitting glass according to a third embodiment of the present invention.

The composition for mid-infrared transmitting glass according to the third embodiment of the present invention (hereinafter, abbreviated as a 'third composition') is prepared by including TeO₂, BaO, and ZnO as raw materials. To prepare the third composition, TeO₂, BaO, and ZnO may be included by the following contents.

1) TeO₂: 65mol%, BaO: 5mol%, ZnO: 30mol%

2) TeO₂: 60mol%, BaO: 10mol%, ZnO: 30mol%

3) TeO₂: 55mol%, BaO: 15mol%, ZnO: 30mol%

4) TeO₂: 50mol%, BaO: 20mol%, ZnO: 30mol%

5) TeO₂: 70mol%, BaO: 10mol%, ZnO: 20mol%

In preparing each third composition, the content of ZnO was varied in the range of 20 to 30 mol%, and according to the variation in the content of ZnO, the content of TeO₂ was varied in the range of 50 to 70 mol%, and the content of La₂O₃ was varied in the range of 5 to 20 mol%. However, if the content of ZnO is reduced to 10 mol%, crystallization occurs in the manufacturing process of the glass.

The glass formed of the third composition including each raw material in the above-described content is shown in FIG. 15.

FIG. 15 is a view illustrating mid-infrared transmitting glass according to the third embodiment of the present invention.

FIGS. 3(a) to (e) show the glass implemented with each third composition. Referring to FIGS. 3(a) to (e), it could be identified that crystallization did not proceed in each third composition as they were implemented into glass.

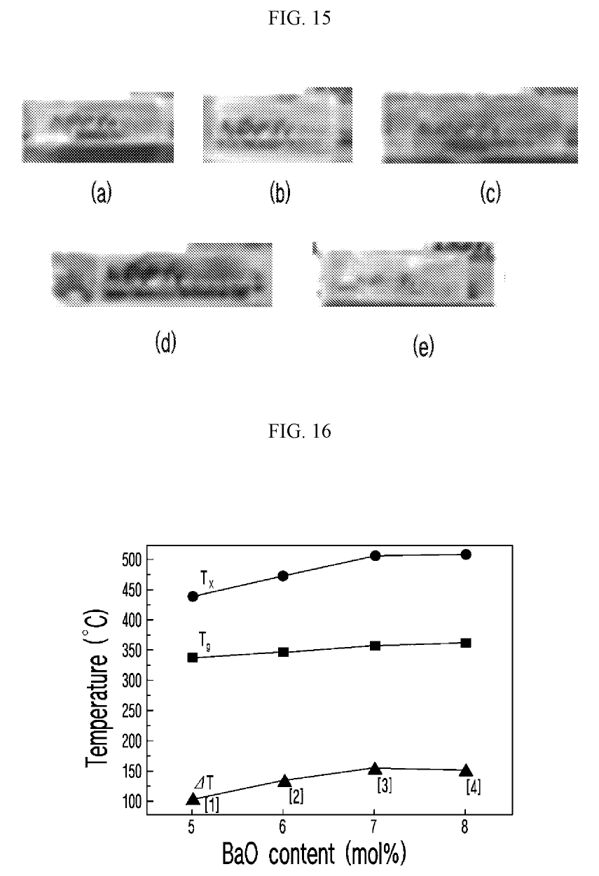

FIG. 16 is a graph illustrating the glass transition temperature, the crystallization temperature, and the thermal stability according to the composition of a composition for mid-infrared light transmitting glass according to the third embodiment of the present invention.

Referring to the graph shown in FIG. 16, it could be identified that the third compositions all had thermal stability of 100°C or higher regardless of the content of BaO. In particular, as the content of BaO in the third composition increased, the composition had higher thermal stability.

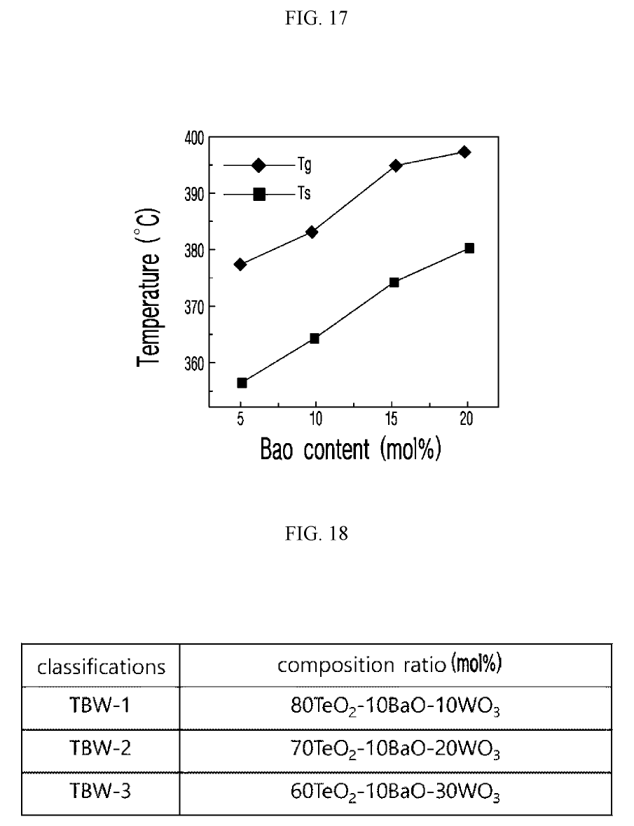

FIG. 17 is a graph illustrating the glass transition temperature and softening temperature according to the composition of the composition for mid-infrared light transmitting glass according to the third embodiment of the present invention.

Referring to the graph shown in FIG. 17, it could be identified that all of the second composition had a softening temperature significantly lower than the reference value (550°C) regardless of the content of BaO in the third compositions. As the content of BaO in the third composition decreased, the composition had a lower softening temperature.

FIG. 18 is a view illustrating the content of components constituting a composition for mid-infrared transmitting glass according to a fourth embodiment of the present invention.

The composition for mid-infrared transmitting glass according to the fourth embodiment of the present invention (hereinafter, abbreviated as a 'fourth composition') is prepared by including TeO₂, BaO, and WO₃ as raw materials. To prepare the fourth composition, TeO₂, BaO, and WO₃ may be included by the following contents.

1) TeO₂: 80mol%, BaO: 10mol%, WO₃: 10mol%

2) TeO₂: 70mol%, BaO: 10mol%, WO₃: 20mol%

3) TeO₂: 60mol%, BaO: 10mol%, WO₃: 30mol%

In preparing each fourth composition, the content of WO₃ was varied and, as the content of WO₃ was varied, the content of TeO₂ was varied as well. However, if the content of WO₃ exceeds 30 mol% or the content of BaO exceeds 10 mol%, crystallization occurs in the manufacturing process of glass.

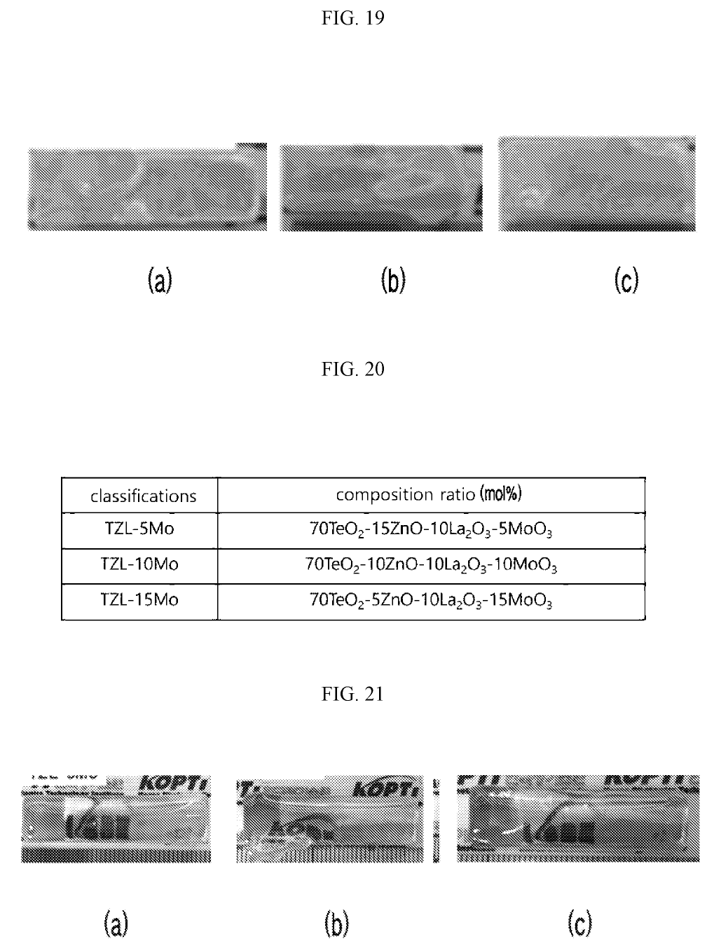

The glass formed of the fourth composition including each raw material in the above-described content is shown in FIG. 19.

FIG. 19 is a view illustrating mid-infrared transmitting glass according to the fourth embodiment of the present invention.

FIGS. 19(a) to (c) show the glass implemented with each fourth composition. Referring to FIGS. 19(a) to (c), it could be identified that crystallization did not proceed in each fourth composition as they were implemented into glass.

FIG. 20 is a view illustrating the content of components constituting a composition for mid-infrared transmitting glass according to a fifth embodiment of the present invention.

The composition for mid-infrared transmitting glass according to the fifth embodiment of the present invention (hereinafter, abbreviated as a 'fifth composition') is prepared by including TeO₅, ZnO, and La₂O₃ as main materials and MoO₃ as a dopant. To prepare the fifth composition, TeO₂, ZnO, La₂O₃ and MoO₃ are included in a ratio of 70:(20-x):10:x, and may be included by the following contents.
1) TeO₂: 70mol%, ZnO: 15mol%, La₂O₃: 10mol%, MoO₃: 5mol%
2) TeO₂: 70mol%, ZnO: 10mol%, La₂O₃: 10mol%, MoO₃: 10mol%
3) TeO₂: 70mol%, ZnO: 5mol%, La₂O₃: 10mol%, MoO₃: 15mol%

In preparing each fifth composition, the content of MoO₃ was varied and, as the content of MoO₃ was varied, the content of ZnO was varied as well.

FIG. 21 is a view illustrating mid-infrared transmitting glass according to the fifth embodiment of the present invention.

FIGS. 21(a) to (c) show the glass formed of each fifth composition. Referring to FIGS. 21(a) to (c), it could be identified that crystallization did not proceed in each fifth composition as they were implemented into glass.

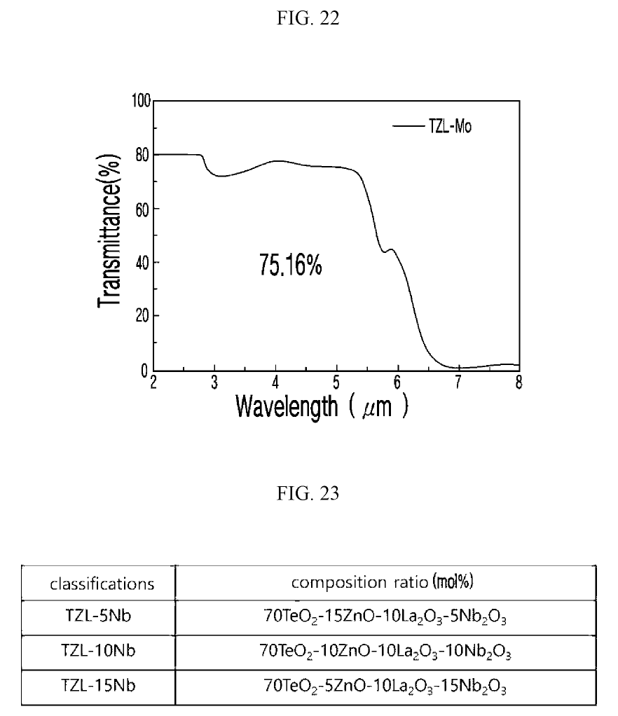

FIG. 22 is a graph illustrating the transmittance for each wavelength of a composition for mid-infrared transmitting glass according to the fifth embodiment of the present invention.

Each fifth composition has a light transmittance as in the graph shown in FIG. 22. Here, each fifth compositions showed a high transmittance of 75% or more on average, at a wavelength from 3 to 5 μm, which is a mid-infrared wavelength band. It could be identified that as the fifth composition adds the dopant, the transmittance among the optical properties of the composition was enhanced as compared with a composition without the dopant.

Furthermore, the glass formed of each fifth composition also has excellent releasability, so that anti-reflection coating may be performed on the surface. It could be identified that when anti-reflection coating is performed on the surface of the glass formed of each fifth compositions, the composition secured a mid-infrared transmittance (e.g., 94%) equal to or higher than the above-described transmittance.

FIG. 23 is a view illustrating the content of components constituting a composition for mid-infrared transmitting glass according to a sixth embodiment of the present invention.

The composition for mid-infrared transmitting glass according to the sixth embodiment of the present invention (hereinafter, abbreviated as a 'sixth composition') is prepared by including TeO₂, ZnO, and La₂O₃ as main materials and Nb₂O₃ as a dopant. To prepare the sixth composition, TeO₂, ZnO, La₂O₃ and Nb₂O₃ are included in a ratio of 70:(20-x):10:x, and may be included by the following contents.
1) TeO₂: 70mol%, ZnO: 15mol%, La₂O₃: 10mol%, Nb₂O₃: 5mol%
2) TeO₂: 70mol%, ZnO: 10mol%, La₂O₃: 10mol%, Nb₂O₃: 10mol%
3) TeO₂: 70mol%, ZnO: 5mol%, La₂O₃: 10mol%, Nb₂O₃: 15mol%

In preparing each sixth composition, the content of Nb₂O₃ was varied and, as the content of Nb₂O₃ was varied, the content of ZnO was varied as well.

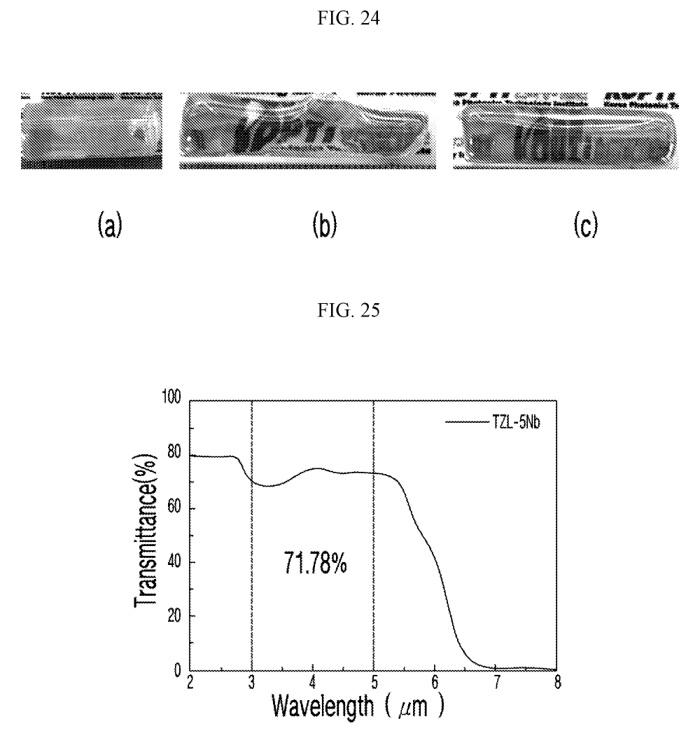

FIG. 24 is a view illustrating mid-infrared transmitting glass according to the sixth embodiment of the present invention.

FIGS. 24(a) to (c) show the glass formed of each sixth composition. Referring to FIGS. 24(a) to (c), it could be identified that crystallization did not proceed in each sixth composition as they were implemented into glass.

FIG. 25 is a graph illustrating the transmittance for each wavelength of a composition for mid-infrared transmitting glass according to the sixth embodiment of the present invention.

Each sixth composition has a light transmittance as in the graph shown in FIG. 25. Here, each sixth compositions showed a high transmittance of 71% or more on average, at a wavelength from 2 to 5 μm, which is a mid-infrared wavelength band. Accordingly, each sixth compositions has properties suitable for being implemented as mid-infrared transmitting glass. In other words, it could be identified that, although Nb₂O₃ was included as a dopant, the optical properties of the glass were not impaired. Furthermore, the glass formed of each sixth composition also has excellent releasability, so that anti-reflection coating may be performed on the surface. When anti-reflection coating is performed on the surface of the glass formed of each sixth composition, a mid-infrared transmittance equal to or higher than the above-described transmittance may be secured.

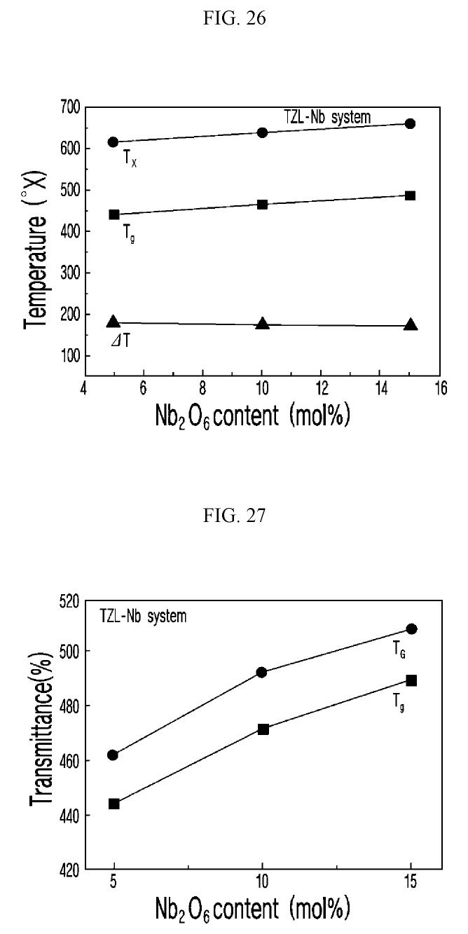

FIG. 26 is a graph illustrating the glass transition temperature, the crystallization temperature, and the thermal stability according to the composition of a composition for mid-infrared light transmitting glass according to the sixth embodiment of the present invention.

Referring to the graph shown in FIG. 26, it could be identified that the sixth compositions all had significantly excellent thermal stability of 170°C or higher regardless of the content of Nb₂O₃. As the content of Nb₂O₃ in the sixth composition decreased, the thermal stability increased. It could be identified that as the dopant Nb₂O₃ was included together with the main components, the thermal stability of the composition was enhanced.

FIG. 27 is a graph illustrating the glass transition temperature and softening temperature according to the composition of the composition for mid-infrared light transmitting glass according to the sixth embodiment of the present invention.

Referring to the graph shown in FIG. 27, it could be identified that all of the sixth composition had a softening temperature lower than the reference value (550°C) regardless of the content of Nb₂O₃ in the sixth compositions. As the content of Nb₂O₃ in the sixth composition decreased, the composition had a lower softening temperature.

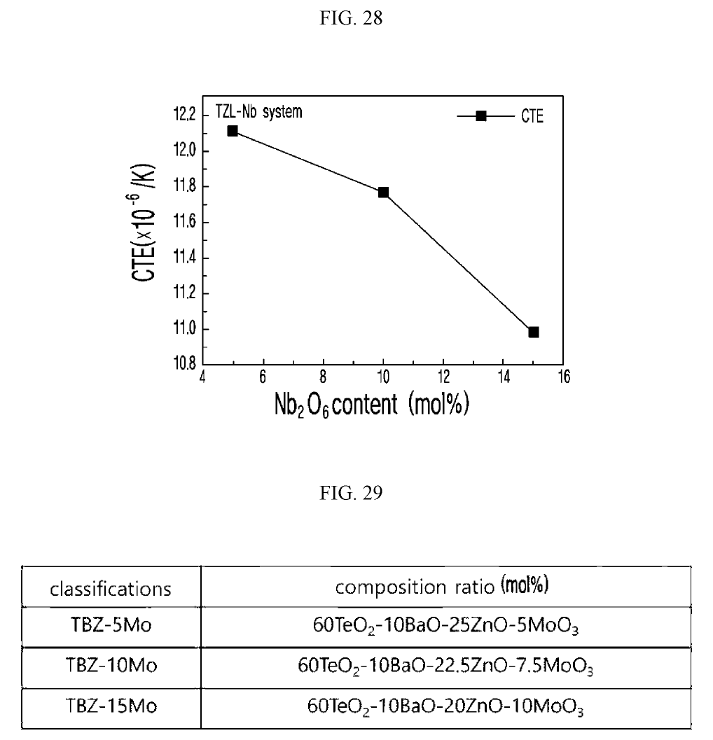

FIG. 28 is a graph illustrating the thermal expansion coefficient according to the composition of a composition for mid-infrared transmitting glass according to the sixth embodiment of the present invention.

Coefficient of thermal expansion (CTE) refers to the degree to which the volume of an object changes when the temperature of the object changes. That the coefficient of thermal expansion of the composition for glass or glass is high indicates that, when the glass or an optical component into which the glass is formed is exposed to an environment with many changes in temperature, its volume may be changed up to a meaningful level. Since it is preferable that the composition for glass or glass is insensitive to temperature change, it is preferable that the thermal expansion coefficient of the composition for glass or glass is a predetermined reference value or less. Here, the reference value may be 15(*10-6/K).

Referring to the graph shown in FIG. 28, it could be identified that all of the sixth compositions had a thermal expansion coefficient significantly lower than the reference value (15*10⁻⁶/K) regardless of the content of Nb₂O₃ in the sixth compositions. As the content of Nb₂O₃ in the sixth composition increased, the composition had a lower thermal expansion coefficient.

FIG. 29 is a view illustrating the content of components constituting a composition for mid-infrared transmitting glass according to a seventh embodiment of the present invention.

The composition for mid-infrared transmitting glass according to the seventh embodiment of the present invention (hereinafter, abbreviated as a 'seventh composition') is prepared by including TeO₂, BaO, and ZnO as main materials and MoO₃ as a dopant. To prepare the seventh composition, TeO₂, BaO, ZnO, and MoO₃ are included in a ratio of 60:10:(30-x):x, and may be included by the following contents.
1) TeO₂: 60mol%, BaO: 10mol%, ZnO: 25mol%, MoO₃: 5mol%
2) TeO₂: 60mol%, BaO: 10mol%, ZnO: 22.5mol%, MoO₃: 7.5mol%
3) TeO₂: 60mol%, BaO: 10mol%, ZnO: 20mol%, MoO₃: 10mol%

In preparing each seventh composition, the content of MoO₃ was varied and, as the content of MoO₃ was varied, the content of ZnO was varied as well.

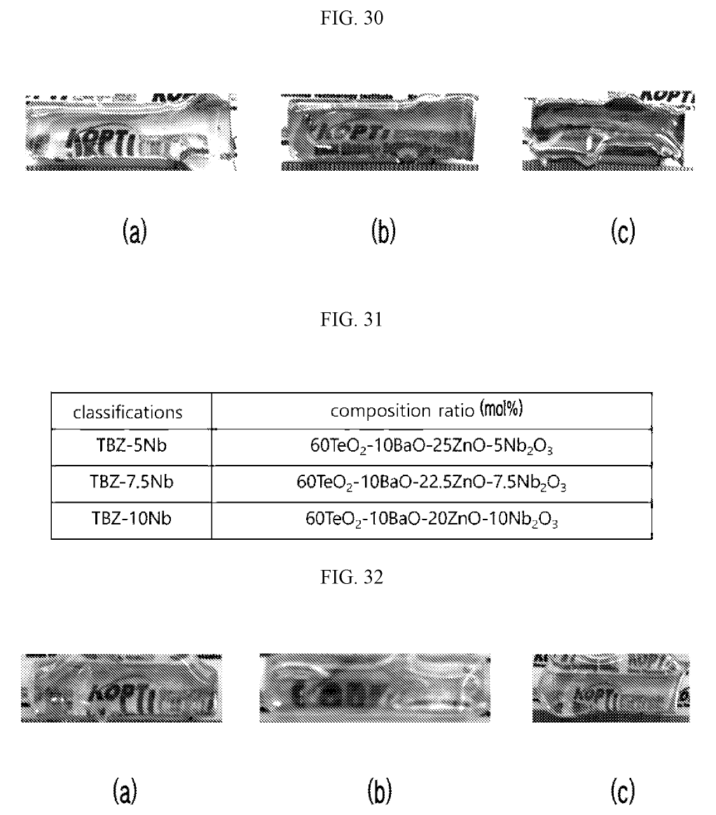

FIG. 30 is a view illustrating mid-infrared transmitting glass according to the seventh embodiment of the present invention.

FIGS. 30(a) to (c) show the glass formed of each seventh composition. Referring to FIGS. 30(a) to (c), it could be identified that crystallization did not proceed in each seventh composition as they were implemented into glass.

FIG. 31 is a view illustrating the content of components constituting a composition for mid-infrared transmitting glass according to an eighth embodiment of the present invention.

The composition for mid-infrared transmitting glass according to the eighth embodiment of the present invention (hereinafter, abbreviated as an 'eighth composition') is prepared by including TeO₂, BaO, and ZnO as main materials and Nb₂O₃ as a dopant. To prepare the eighth composition, TeO₂, BaO, ZnO, and Nb₂O₃ are included in a ratio of 60:10:(30-x):x, and may be included by the following contents.
1) TeO₂: 60mol%, BaO: 10mol%, ZnO: 25mol%, Nb₂O₃: 5mol%
2) TeO₂: 60mol%, BaO: 10mol%, ZnO: 22.5mol%, Nb₂O₃: 7.5mol%
3) TeO₂: 60mol%, BaO: 10mol%, ZnO: 20mol%, Nb₂O₃: 10mol%

In preparing each eighth composition, the content of Nb₂O₃ was varied and, as the content of Nb₂O₃ was varied, the content of ZnO was varied as well.

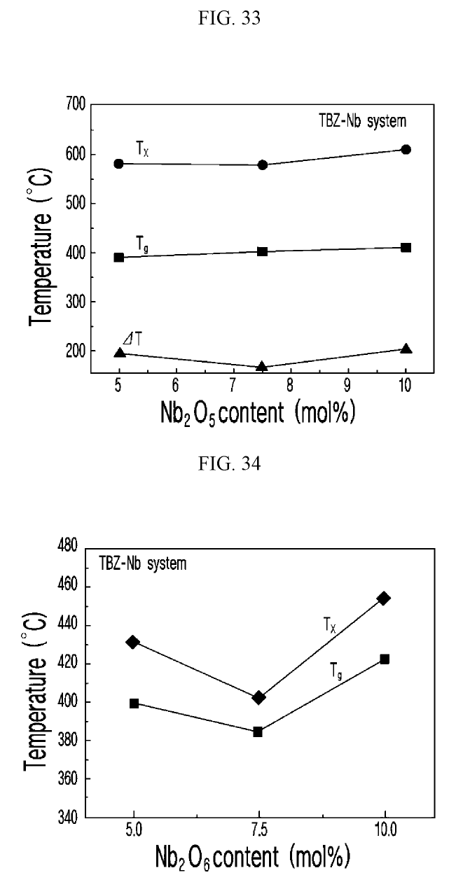

FIG. 32 is a view illustrating mid-infrared transmitting glass according to the eighth embodiment of the present invention.

FIGS. 32(a) to (c) show the glass formed of each eighth composition. Referring to FIGS. 32(a) to (c), it could be identified that crystallization did not proceed in each eighth composition as they were implemented into glass.

FIG. 33 is a graph illustrating the glass transition temperature, the crystallization temperature, and the thermal stability according to the composition of a composition for mid-infrared light transmitting glass according to the eighth embodiment of the present invention.

Referring to the graph shown in FIG. 33, it could be identified that the eighth compositions all had significantly excellent thermal stability of 190°C or higher regardless of the content of Nb₂O₃. As the content of Nb₂O₃ in the eighth composition decreased or increased with respect to 7.5mol%, the thermal stability increased. It could be identified that as the dopant Nb₂O₃ was included together with the main components, the thermal stability of the composition was enhanced.

FIG. 34 is a graph illustrating the glass transition temperature and softening temperature according to the composition of the composition for mid-infrared light transmitting glass according to the eighth embodiment of the present invention.

Referring to the graph shown in FIG. 34, it could be identified that all of the eighth composition had a softening temperature significantly lower than the reference value (550°C) regardless of the content of Nb₂O₃ in the eighth compositions. When the content of Nb₂O₃ in the eighth composition was 7.5mol%, the composition had the lowest softening temperature. It could be identified that as the dopant Nb₂O₃ was included together with the main components, the softening temperature was significantly decreased.

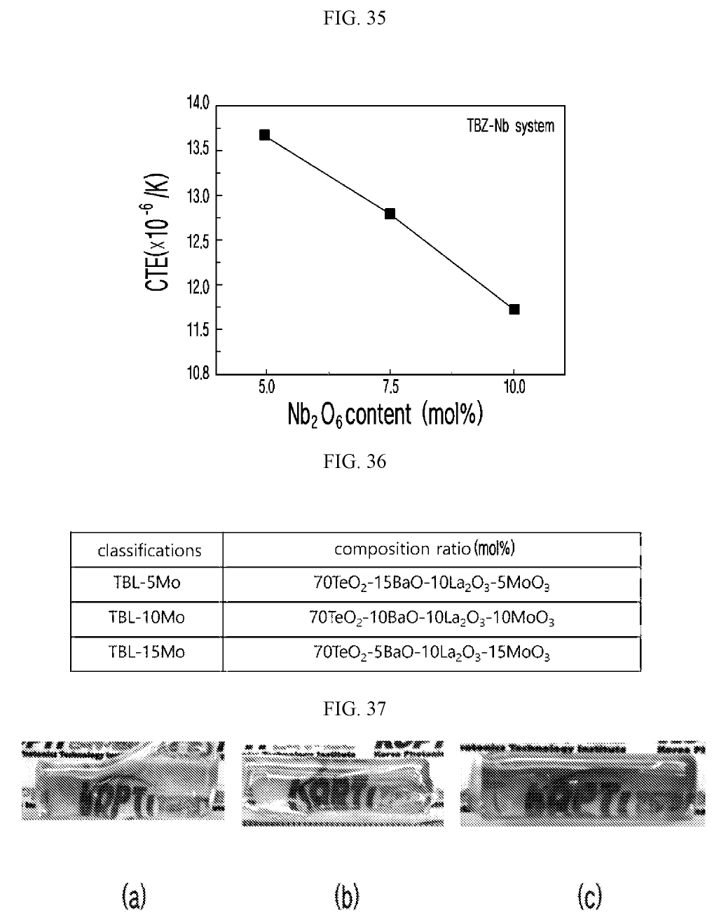

FIG. 35 is a graph illustrating the thermal expansion coefficient according to the composition of a composition for mid-infrared transmitting glass according to the eighth embodiment of the present invention.

Referring to the graph shown in FIG. 35, it could be identified that all of the eighth compositions had a thermal expansion coefficient significantly lower than the reference value (15*10⁻⁶/K) regardless of the content of Nb₂O₃ in the eighth compositions. As the content of Nb₂O₃ in the eighth composition increased, the composition had a lower thermal expansion coefficient.

FIG. 36 is a view illustrating the content of components constituting a composition for mid-infrared transmitting glass according to a ninth embodiment of the present invention.

The composition for mid-infrared transmitting glass according to the ninth embodiment of the present invention (hereinafter, abbreviated as a 'ninth composition') is prepared by including TeO₂, BaO, and La₂O₃ as main materials and MoO₃ as a dopant. To prepare the ninth composition, TeO₂, BaO, La₂O₃ and MoO₃ are included in a ratio of 70:(20-x):10:x, and may be included by the following contents.
1) TeO₂: 70mol%, BaO: 15mol%, La₂O₃: 10mol%, MoO₃: 5mol%
2) TeO₂: 70mol%, BaO: 10mol%, La₂O₃: 10mol%, MoO₃: 10mol%
3) TeO₂: 70mol%, BaO: 5mol%, La₂O₃: 10mol%, MoO₃: 15mol%

In preparing each ninth composition, the content of MoO₃ was varied and, as the content of MoO₃ was varied, the content of BaO was varied as well.

FIG. 37 is a view illustrating mid-infrared transmitting glass according to the ninth embodiment of the present invention.

FIGS. 37(a) to (c) show the glass formed of each ninth composition. Referring to FIGS. 37(a) to (c), it could be identified that crystallization did not proceed in each ninth composition as they were implemented into glass.

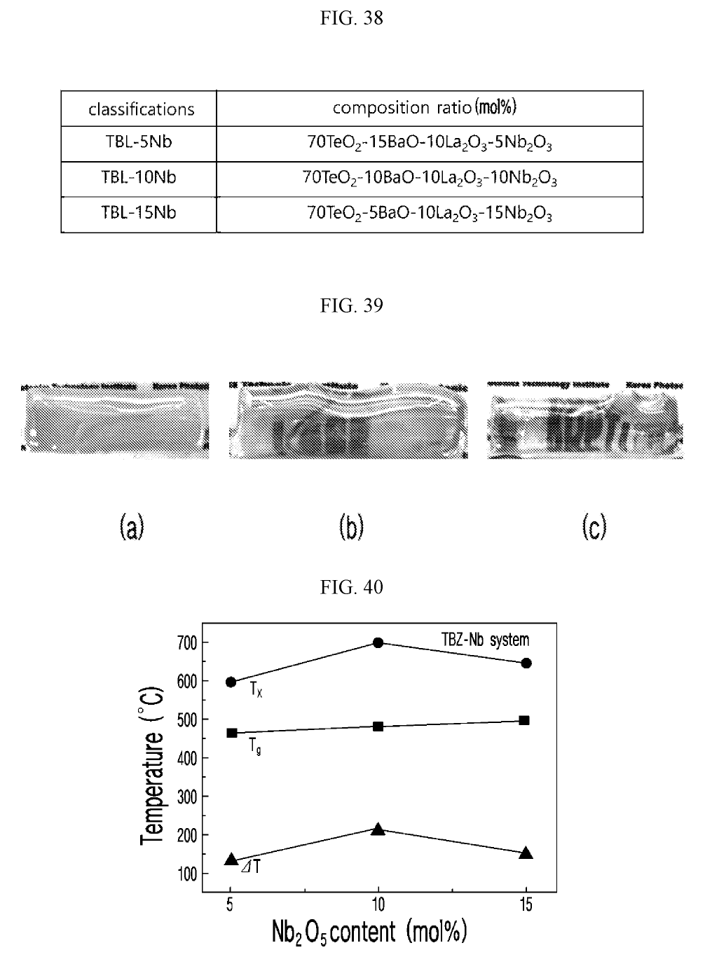

FIG. 38 is a view illustrating the content of components constituting a composition for mid-infrared transmitting glass according to a tenth embodiment of the present invention.

The composition for mid-infrared transmitting glass according to the tenth embodiment of the present invention (hereinafter, abbreviated as a 'tenth composition') is prepared by including TeO₂, BaO, and La₂O₃ as main materials and Nb₂O₃ as a dopant. To prepare the tenth composition, TeO₂, BaO, La₂O₃ and Nb₂O₃ are included in a ratio of 70:(20-x):10:x, and may be included by the following contents.
1) TeO₂: 70mol%, BaO: 15mol%, La₂O₃: 10mol%, Nb₂O₃: 5mol%
2) TeO₂: 70mol%, BaO: 10mol%, La₂O₃: 10mol%, Nb₂O₃: 10mol%
3) TeO₂: 70mol%, BaO: 5mol%, La₂O₃: 10mol%, Nb₂O₃: 15mol%

In preparing each tenth composition, the content of Nb₂O₃ was varied and, as the content of Nb₂O₃ was varied, the content of BaO was varied as well.

FIG. 39 is a view illustrating mid-infrared transmitting glass according to the tenth embodiment of the present invention.

FIGS. 39(a) to (c) show the glass formed of each tenth composition. Referring to FIGS. 39(a) to (c), it could be identified that crystallization did not proceed in each tenth composition as they were implemented into glass.

FIG. 40 is a graph illustrating the glass transition temperature, the crystallization temperature, and the thermal stability according to the composition of a composition for mid-infrared light transmitting glass according to the tenth embodiment of the present invention.

Referring to the graph shown in FIG. 40, it could be identified that the tenth compositions all had significantly excellent thermal stability of 130°C or higher regardless of the content of Nb₂O₃. As the content of Nb₂O₃ in the tenth composition increased, the thermal stability showed a tendency to increase. It could be identified that the composition had significantly excellent thermal stability particularly when the content of Nb₂O₃ was 10mol%.

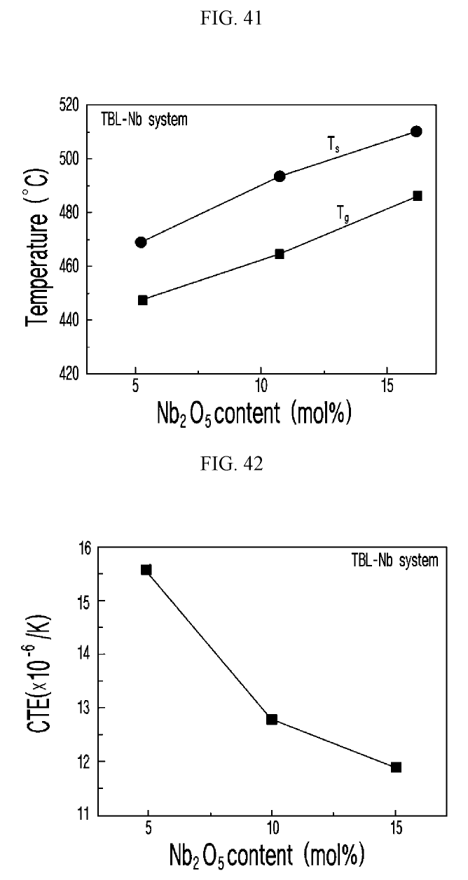

FIG. 41 is a graph illustrating the glass transition temperature and softening temperature according to the composition of the composition for mid-infrared light transmitting glass according to the tenth embodiment of the present invention.

Referring to the graph shown in FIG. 41, it could be identified that all of the tenth composition had a softening temperature lower than the reference value (550°C) regardless of the content of Nb₂O₃ in the tenth compositions. As the content of Nb₂O₃ in the tenth composition decreased, the composition had a lower softening temperature.

FIG. 42 is a graph illustrating the thermal expansion coefficient according to the composition of a composition for mid-infrared transmitting glass according to the tenth embodiment of the present invention.

Referring to the graph shown in FIG. 42, it could be identified that the tenth compositions had a thermal expansion coefficient lower than the reference value (15*10⁻⁶/K) when the content of Nb₂O₃ in the tenth composition was 7.5mol% or more. As the content of Nb₂O₃ in the tenth composition increased, the composition had a lower thermal expansion coefficient.

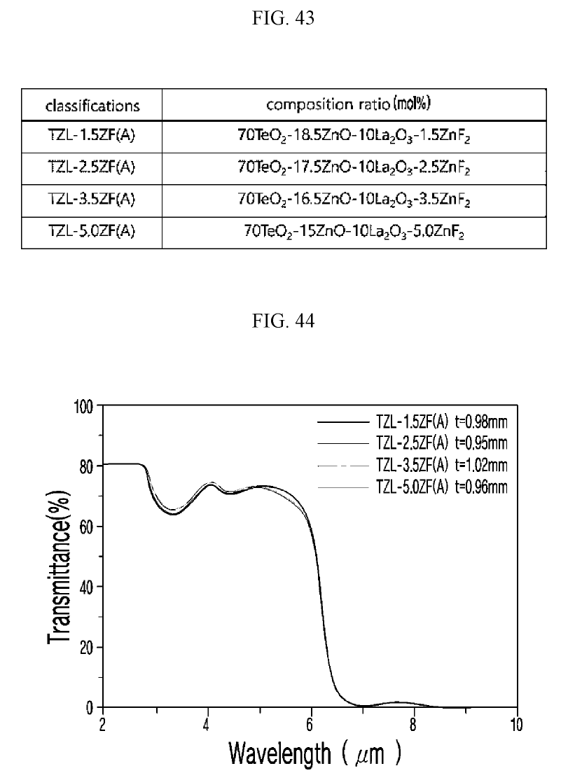

FIG. 43 is a view illustrating the content of components constituting a composition for mid-infrared transmitting glass according to an eleventh embodiment of the present invention.

The composition for mid-infrared transmitting glass according to the eleventh embodiment of the present invention (hereinafter, abbreviated as an 'eleventh composition') is prepared by including TeO₂, ZnO, and La₂O₃ as main materials and ZnF₂ as a dopant. To prepare the eleventh composition, TeO₂, ZnO, La₂O₃ and ZnF₂ are included in a ratio of 70:(20-x):10:x, and may be included by the following contents.

1) TeO₂: 70mol%, ZnO: 18.5mol%, La₂O₃: 10mol%, ZnF₂: 1.5mol%

2) TeO₂: 70mol%, ZnO: 17.5mol%, La₂O₃: 10mol%, ZnF₂: 2.5mol%

3) TeO₂: 70mol%, ZnO: 16.5mol%, La₂O₃: 10mol%, ZnF₂: 3.5mol%

4) TeO₂: 70mol%, ZnO: 15mol%, La₂O₃: 10mol%, ZnF₂: 5.0mol%

In preparing each eleventh composition, the content of ZnF₂ was varied and, as the content of ZnF₂ was varied, the content of ZnO was varied as well. However, if the content of ZnF₂ exceeds 5.0 mol%, crystallization occurs in the manufacturing process of the glass.

FIG. 44 is a graph illustrating the transmittance for each wavelength of a composition for mid-infrared transmitting glass according to the eleventh embodiment of the present invention.

Each eleventh composition has a light transmittance as in the graph shown in FIG. 44. Here, each eleventh compositions showed a transmittance of 69% or more on average, at a wavelength from 3 to 5 μm, which is a mid-infrared wavelength band. Thus, it could be identified that, although ZnF₂ was included as a dopant, the optical properties of the glass were not impaired. Furthermore, the glass formed of each eleventh composition has excellent releasability, so that anti-reflection coating may be performed on the surface. When anti-reflection coating is performed on the surface of the glass formed of each eleventh composition, the composition may secure a mid-infrared transmittance equal to or higher than the above-described transmittance.

FIG. 45 is a graph illustrating the glass transition temperature, the crystallization temperature, and the thermal stability according to the composition of a composition for mid-infrared light transmitting glass according to the eleventh embodiment of the present invention.

Referring to the graph shown in FIG. 45, it could be identified that the eleventh compositions all had significantly excellent thermal stability of 150°C or higher regardless of the content of ZnF₂. As the content of ZnF₂ in the eleventh composition increased, the thermal stability showed a tendency to decrease.

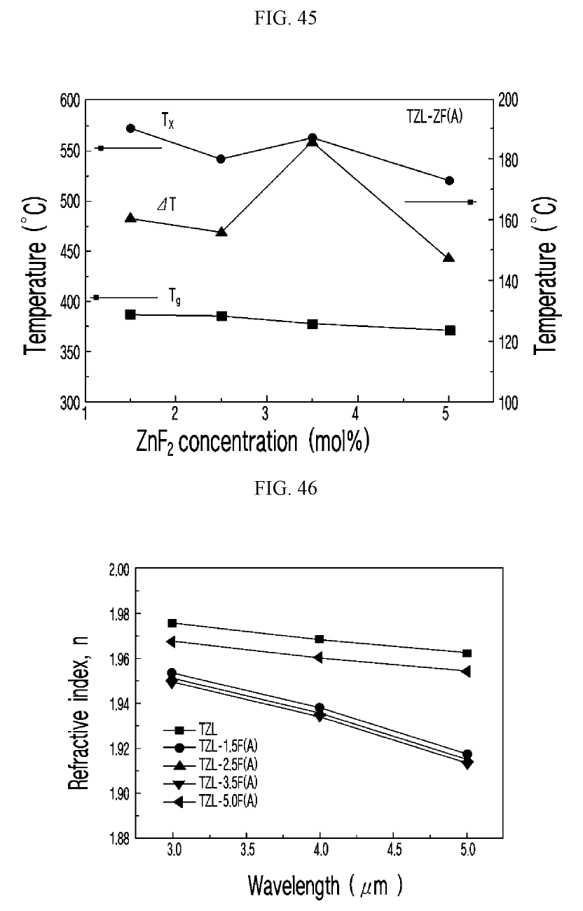

FIG. 46 is a graph illustrating the refractive index according to the composition of a composition for mid-infrared transmitting glass according to the eleventh embodiment of the present invention.

Referring to the graph shown in FIG. 46, the composition (TZL-ZF(A)), which included ZnF2 as a dopant showed optical properties (reduction in Abbe number) of a reduced refractive index and an increased dispersion value as compared with the composition (TZL) which includes TeO₂, ZnO, and La₂O₃ as main components and adds no dopant. All the compositions had excellent optical properties of a refractive index of 1.9 or more in the mid-infrared wavelength band (3 to 5 μm), regardless of whether a dopant was added. Accordingly, the eleventh composition may be designed as a lens having a thin thickness and thus may be manufactured as an optical system having a thin structure. Further, since the surface depth (shape) of the lens may be designed to be small, the manufacturing yield of the lens may be enhanced when the lens is manufactured with the eleventh composition.

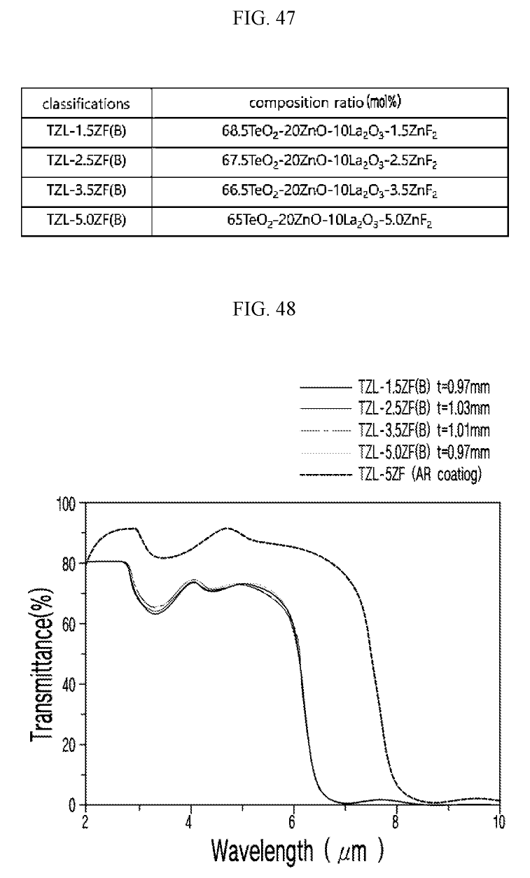

FIG. 47 is a view illustrating the content of components constituting a composition for mid-infrared transmitting glass according to a twelfth embodiment of the present invention.

The composition for mid-infrared transmitting glass according to the twelfth embodiment of the present invention (hereinafter, abbreviated as a 'twelfth composition') is prepared by including TeO₂, ZnO, and La₂O₃ as main materials and ZnF₂ as a dopant, like the eleventh composition. However, unlike the eleventh composition, to prepare the twelfth composition, TeO₂, ZnO, La₂O₃ and ZnF₂ are included in a ratio of (70-x):20:10:x, and may be included by the following contents.

1) TeO₂: 68.5mol%, ZnO: 20mol%, La₂O₃: 10mol%, ZnF₂: 1.5mol%

2) TeO₂: 67.5mol%, ZnO: 20mol%, La₂O₃: 10mol%, ZnF₂: 2.5mol%

3) TeO₂: 66.5mol%, ZnO: 20mol%, La₂O₃: 10mol%, ZnF₂: 3.5mol%

4) TeO₂: 65mol%, ZnO: 20mol%, La₂O₃: 10mol%, ZnF₂: 5.0mol%

In preparing each twelfth composition, the content of ZnF₂ was varied and, as the content of ZnF₂ was varied, the content of TeO₂ was varied as well. However, if the content of ZnF₂ exceeds 5.0 mol%, crystallization occurs in the manufacturing process of the glass.

FIG. 48 is a graph illustrating the transmittance for each wavelength of a composition for mid-infrared transmitting glass according to the twelfth embodiment of the present invention.

Each twelfth composition has a light transmittance as in the graph shown in FIG. 48. Here, each twelfth compositions showed a transmittance of 70% or more on average, at a wavelength from 3 to 5 μm, which is a mid-infrared wavelength band. Thus, it could be identified that, although ZnF₂ was included as a dopant in the combination of the main components, the optical properties of the glass were not impaired.

Furthermore, the glass formed of each twelfth composition has excellent releasability, so that anti-reflection coating may be performed on the surface. It could be identified that when anti-reflection coating is performed on the surface of the glass formed of each twelfth compositions, the composition secured a mid-infrared transmittance (e.g., 86% or more) equal to or higher than the above-described transmittance.

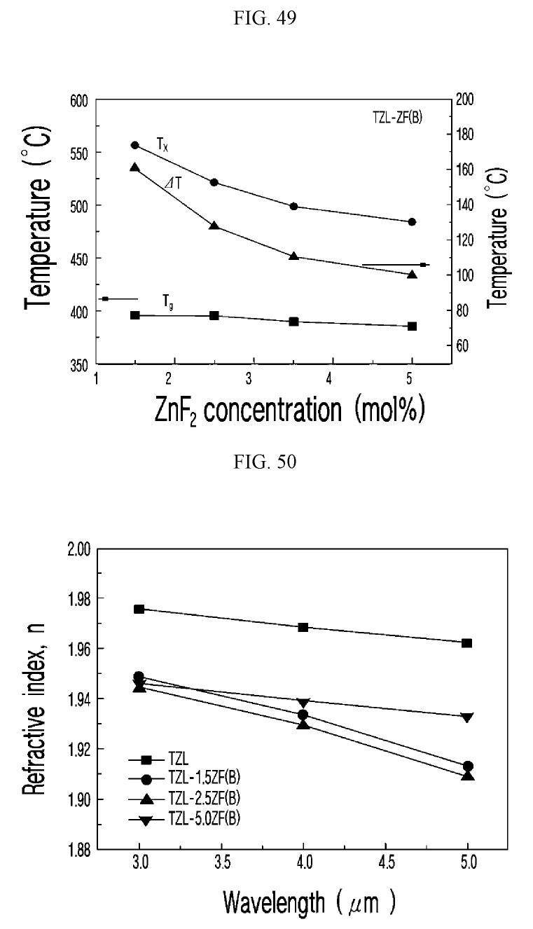

FIG. 49 is a graph illustrating the glass transition temperature, the crystallization temperature, and the thermal stability according to the composition of a composition for mid-infrared light transmitting glass according to the twelfth embodiment of the present invention.

Referring to the graph shown in FIG. 49, it could be identified that the twelfth compositions all had thermal stability of 100°C or higher regardless of the content of ZnF₂. As the content of ZnF₂ in the twelfth composition increased, the thermal stability decreased.

FIG. 50 is a graph illustrating the refractive index according to the composition of a composition for mid-infrared transmitting glass according to the twelfth embodiment of the present invention.

Referring to the graph shown in FIG. 50, the composition (TZL-ZF(B)), which included ZnF₂ as a dopant showed optical properties (reduction in Abbe number) of a reduced refractive index and an increased dispersion value as compared with the composition (TZL) which includes TeO₂, ZnO, and La₂O₃ as main components and adds no dopant. In particular, the composition which adds 5mol% of ZnF₂ showed the optical properties (increase in Abbe number) of an increased refractive index and a reduced dispersion value as compared with other compositions. All the compositions had excellent optical properties of a refractive index of 1.9 or more in the mid-infrared wavelength band (3 to 5 μm), regardless of whether a dopant was added. Accordingly, the twelfth composition may have the same advantages as the eleventh composition.

Further, as the dispersion value decreases, the corresponding optical configuration is advantageous in correcting chromatic aberration because the focal length deviation according to the wavelength reduces. Since the optical configuration is advantageous in correcting chromatic aberration, it may have excellent image resolution. Accordingly, an optical configuration formed of a composition having a relatively reduced dispersion value may secure an excellent image resolution.

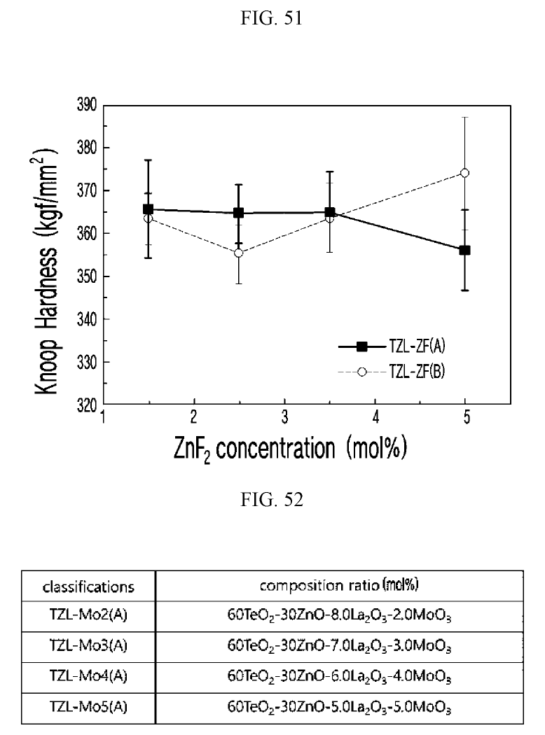

FIG. 51 is a graph illustrating the hardness according to the composition of a composition for mid-infrared transmitting glass according to the twelfth embodiment of the present invention.

Referring to FIG. 51, the glass formed of the eleventh composition showed a tendency to have an increasing hardness as the content of ZnF₂ decreased, and the glass formed of the twelfth composition showed a tendency to have an increasing hardness as the content of ZnF₂ increased. It could be identified that when the content of ZnF₂ was 1.5 mol%, the glass formed of the eleventh composition had the highest hardness, and the glass formed of the eleventh composition had a hardness of 335KgF/mm² or more regardless of the content. It could be identified that when the content of ZnF₂ was 5.0 mol%, the glass formed of the twelfth composition had the highest hardness, and the glass formed of the twelfth composition had a hardness of 335KgF/mm² or more regardless of the content.

It could also be identified that, as compared with glass formed of a composition which does not include ZnF₂ as a dopant, the glass formed of a composition containing ZnF₂ as a dopant had a predetermined level or more of hardness on average.

FIG. 52 is a view illustrating the content of components constituting a composition for mid-infrared transmitting glass according to a thirteenth embodiment of the present invention.

The composition for mid-infrared transmitting glass according to the thirteenth embodiment of the present invention (hereinafter, abbreviated as a 'thirteenth composition') is prepared by including TeO₂, ZnO, and La₂O₃ as main materials and MoO₃ as a dopant. To prepare the thirteenth composition, TeO₂, ZnO, La₂O₃ and MoO₃ are included in a ratio of 60:30:(10-x):x, and may be included by the following contents.

1) TeO₂: 60mol%, ZnO: 30mol%, La₂O₃: 8.0mol%, MoO₃: 2.0mol%

2) TeO₂: 60mol%, ZnO: 30mol%, La₂O₃: 7.0mol%, MoO₃: 3.0mol%

3) TeO₂: 60mol%, ZnO: 30mol%, La₂O₃: 6.0mol%, MoO₃: 4.0mol%

4) TeO₂: 60mol%, ZnO: 30mol%, La₂O₃: 5.0mol%, MoO₃: 5.0mol%

In preparing each thirteenth composition, the content of MoO₃ was varied and, as the content of MoO₃ was varied, the content of La₂O₃ was varied as well.

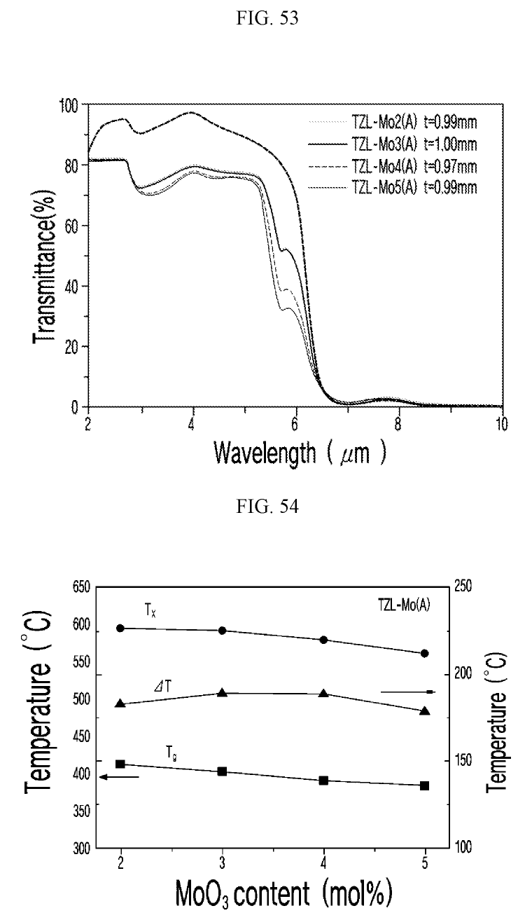

FIG. 53 is a graph illustrating the transmittance for each wavelength of a composition for mid-infrared transmitting glass according to the thirteenth embodiment of the present invention.

Each thirteenth composition has a light transmittance as in the graph shown in FIG. 53. Here, each thirteenth compositions showed a transmittance of 70% or more on average, at a wavelength from 3 to 5 μm, which is a mid-infrared wavelength band. In particular, a composition containing 2.0 mol% or 3.0 mol% of MoO₃ showed a fairly good mid-infrared transmittance of 76% or more. Accordingly, each thirteenth compositions has properties suitable for being implemented as mid-infrared transmitting glass.

Furthermore, the glass formed of each thirteenth composition has excellent releasability, so that anti-reflection coating may be performed on the surface. It could be identified that when anti-reflection coating is performed on the surface of the glass formed of each thirteenth composition, the glass secured a mid-infrared transmittance (e.g., 94% or more) equal to or higher than the above-described transmittance.

FIG. 54 is a graph illustrating the glass transition temperature, the crystallization temperature, and the thermal stability according to the composition of a composition for mid-infrared light transmitting glass according to the thirteenth embodiment of the present invention.

Referring to the graph shown in FIG. 54, it could be identified that the thirteenth compositions all had significantly excellent thermal stability of 175°C or higher regardless of the content of MoO₃. As the content of MoO₃ in the thirteenth composition increased, the thermal stability showed a tendency to increase. It could be identified that as the dopant MoO₃ was included, the thermal stability of the composition was significantly enhanced.

In other words, it could be identified that although MoO3 was included as a dopant, the optical properties of the composition were not impaired, and the optical properties of the composition became more excellent than those of compositions not containing the dopant.

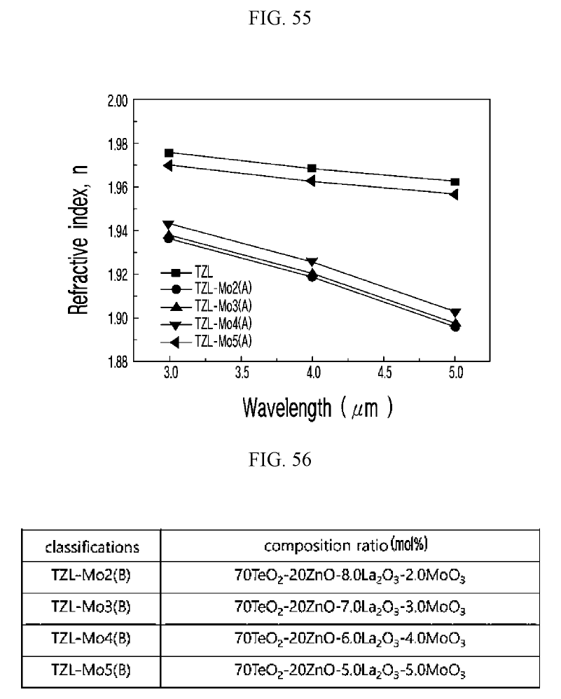

FIG. 55 is a graph illustrating the refractive index according to the composition of a composition for mid-infrared transmitting glass according to the thirteenth embodiment of the present invention.

Referring to the graph shown in FIG. 55, the composition (TZL-Mo(A)), which included MoO₃ as a dopant showed optical properties (reduction in Abbe number) of a reduced refractive index and an increased dispersion value as compared with the composition (TZL) which includes TeO₃, ZnO, and La₂O₃ as main components and adds no dopant. Further, all the compositions had excellent optical properties of a refractive index of 1.9 or more in the mid-infrared wavelength band (3 to 5 μm), regardless of whether a dopant was added. Accordingly, the thirteenth composition may have the same advantages as the twelfth composition or the eleventh composition.

FIG. 56 is a view illustrating the content of components constituting a composition for mid-infrared transmitting glass according to a fourteenth embodiment of the present invention.

The composition for mid-infrared transmitting glass according to the fourteenth embodiment of the present invention (hereinafter, abbreviated as a 'fourteenth composition') is prepared by including TeO₂, ZnO, and La₂O₃ as main materials and MoO₃ as a dopant. However, unlike the thirteenth composition, to prepare the fourteenth composition, TeO₂, ZnO, La₂O₃ and MoO₃ are included in a ratio of 70:20:(10-x):x, and may be included by the following contents.

1) TeO₂: 70mol%, ZnO: 20mol%, La₂O₃: 8.0mol%, MoO₃: 2.0mol%

2) TeO₂: 70mol%, ZnO: 20mol%, La₂O₃: 7.0mol%, MoO₃: 3.0mol%

3) TeO₂: 70mol%, ZnO: 20mol%, La₂O₃: 6.0mol%, MoO₃: 4.0mol%

4) TeO₂: 70mol%, ZnO: 20mol%, La₂O₃: 5.0mol%, MoO₃: 5.0mol%

In preparing each thirteenth composition, the content of MoO₃ was varied and, as the content of MoO₃ was varied, the content of La₂O₃ was varied as well.

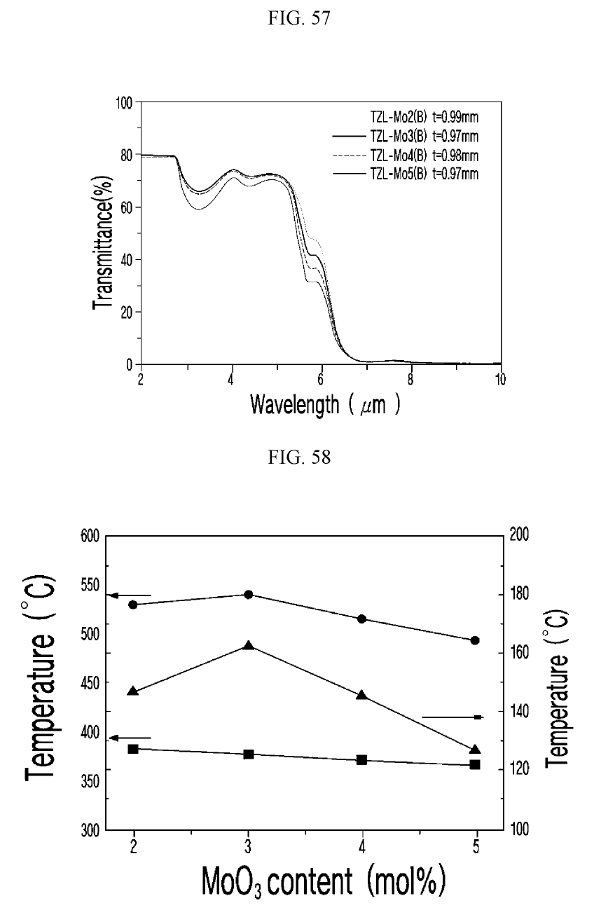

FIG. 57 is a graph illustrating the transmittance for each wavelength of a composition for mid-infrared transmitting glass according to the fourteenth embodiment of the present invention.

Each fourteenth composition has a light transmittance as in the graph shown in FIG. 57. Here, each fourteenth compositions showed a transmittance of 65% or more on average, at a wavelength from 3 to 5 μm, which is a mid-infrared wavelength band. In particular, the other compositions than the composition containing 5.0mol% of MoO₃ showed an excellent mid-infrared transmittance of 69% or more on average. Thus, it could be identified that, although MoO₃ was included as a dopant in the combination of the main components, the optical properties of the glass were not impaired. Furthermore, the glass formed of each fourteenth composition has excellent releasability, so that anti-reflection coating may be performed on the surface. When anti-reflection coating is performed on the surface of the glass formed of each fourteenth composition, a mid-infrared transmittance equal to or higher than the above-described transmittance may be secured.

FIG. 58 is a graph illustrating the glass transition temperature, the crystallization temperature, and the thermal stability according to the composition of a composition for mid-infrared light transmitting glass according to the fourteenth embodiment of the present invention.

Referring to the graph shown in FIG. 58, it could be identified that the fourteenth composition had excellent thermal stability of 130°C or higher regardless of the content of MoO₃. The thermal stability showed a tendency to reduce as the content of MoO₃ in the thirteenth composition increased, and the composition which includes 3.0mol% of MoO₃ had the most excellent thermal stability. It could be identified that as the dopant MoO₃ was included, the thermal stability was enhanced.

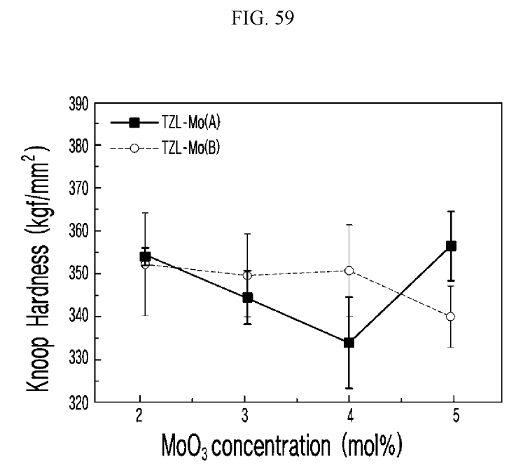

FIG. 59 is a graph illustrating the hardness according to the composition of a composition for mid-infrared transmitting glass according to the fourteenth embodiment of the present invention.

Referring to FIG. 59, the glass formed of the thirteenth composition showed a tendency to have an increasing hardness as the content of MoO₃ decreased or increased from 4.0mol%, and the glass formed of the fourteenth composition showed a tendency to have an increasing hardness as the content of MoO₃ decreased. It could be identified that when the content of MoO₃ was 5.0 mol%, the glass formed of the thirteenth composition had the highest hardness, and the glass formed of the thirteenth composition had a hardness of 335KgF/mm² or more regardless of the content. It could be identified that when the content of MoO₃ was 2.0 mol%, the glass formed of the fourteenth composition had the highest hardness, and the glass formed of the fourteenth composition had a hardness of 335KgF/mm² or more regardless of the content.

Although FIG. 1 illustrates that the steps are sequentially performed, this merely provides an embodiment of the disclosure. It would readily be appreciated by a skilled artisan that the steps of FIG. 1 are not limited to the order shown but may rather be performed in a different order, one or more of the steps may simultaneously be performed, or other various modifications or changes may be made thereto without departing from the scope of the disclosure

The steps or processes described above in connection with FIG. 1 may be implemented as computer-readable code in a recording medium. The computer-readable recording medium includes all types of recording devices storing data readable by a computer system. The computer-readable recording medium includes a storage medium, such as a magnetic storage medium (e.g., a ROM, a floppy disk, or a hard disk) or an optical reading medium (e.g., a CD-ROM or a DVD). Further, the computer-readable recording medium may be distributed to computer systems connected via a network, and computer-readable codes may be stored and executed in a distributed manner.

The above-described embodiments are merely examples, and it will be appreciated by one of ordinary skill in the art various changes may be made thereto without departing from the scope of the present invention. Accordingly, the embodiments set forth herein are provided for illustrative purposes, but not to limit the scope of the present invention, and should be appreciated that the scope of the present invention is not limited by the embodiments. The scope of the present invention should be construed by the following claims, and all technical spirits within equivalents thereof should be interpreted to belong to the scope of the present invention.

### CROSS-REFERENCE TO RELATED APPLICATION

The instant patent application claims priority under 35 U.S.C. 119(a) to Korean Patent Application No. 10-2020-0050852, filed on April 27, 2020, in the Korean Intellectual Property Office, the disclosure of which is herein incorporated by reference in its entirety. The present patent application claims priority to other applications to be filed in other countries, the disclosures of which are also incorporated by reference herein in their entireties.

What is claimed is:

1. A composition for glass transmitting a 3 to 5 µm wavelength band of light by a preset reference value or more,,
wherein the composition consists of TeO₂ two of ZnO, La₂O₃ and BaO, and dopant.

2. The composition of claim 1, wherein the composition consists of 70 mol% of TeO₂ 5 mol% to 15 mol% of ZnO, 10 mol% of La₂O₃ and 5 mol% to 15 mol% of the dopant, and has properties of a refractive index of 1.9 or more, and
wherein the dopant is Nb₂O₃ or MoO₃.

3. The composition of claim 1,
wherein the composition consists of 60 mol% of TeO₂10 mol% of BaO, 20 mol% to 25 mol% of ZnO, and 5 mol% to 10 mol% of dopant, and
wherein the dopant is Nb₂O₃ or MoO₃.

4. The composition of claim 1,
wherein the composition consists of 70 mol% of TeO₂ 5 mol% to 15 mol% of BaO, 10 mol% of La₂O₃ and 5 mol% to 15 mol% of dopant, and
wherein the dopant is Nb₂O₃ or MoO₃.
